(19) United States
(12) Patent Application Publication
(10) Pub. No.: US 2026/0022260 A1
(43) Pub. Date: Jan. 22, 2026

(54) COMPOSITE BOARD INCLUDING CORE AND CAPSTOCK, AND ASSOCIATED METHOD

(71) Applicant: THE AZEK GROUP LLC, Chicago, IL (US)

(72) Inventors: Nicholas Tomko, Chicago, IL (US); Evan Kemp, Chicago, IL (US)

(21) Appl. No.: 19/347,096

(22) Filed: Oct. 1, 2025

Related U.S. Application Data
(63) Continuation-in-part of application No. 18/625,607, filed on Apr. 3, 2024, now Pat. No. 12,448,507.

(51) Int. Cl. C09D 7/65; B32B 25/14; B32B 25/16; C09D 125/12; C09D 127/06; C09D 133/20; E04F 15/02; E04F 15/10

(52) U.S. Cl. CPC C09D 7/65; B32B 25/14; B32B 25/16; C09D 125/12; C09D 127/06; C09D 133/20; E04F 15/02183; E04F 15/107; B32B 2250/02; B32B 2307/712

(57) ABSTRACT

A composite board includes a core and a capstock positioned to at least partially cover the core, where the capstock includes (a) a thermoplastic elastomer, where the thermoplastic elastomer does not include thermoplastic polyurethane (TPU), and (b) a blend of thermoplastic matrix polymers, where the blend thermoplastic matrix polymers includes, based on a total weight of the capstock, 10 wt. % to 70 wt. % polyvinyl chloride (PVC), 1 wt. % to 60 wt. % acrylonitrile-styrene-acrylate (ASA), and 1 wt. % to 60 wt. % styrene-acrylonitrile (SAN).

### CROSS REFERENCE TO RELATED APPLICATION

This application is a continuation-in-part of U.S. application Ser. No. 18/625,607, filed Apr. 3, 2024, the entire disclosure of which is hereby incorporated by reference herein in its entirety.

### FIELD

The present invention relates to a building material, and, more specifically, to a composite board.

### BACKGROUND

Conventional composite boards includes a core, and a capstock covering the core.

### SUMMARY

The claims, rather than the summary, define covered embodiments of the present invention. The summary is a high-level overview of various aspects of the invention and introduces some concepts that are further described in the detailed description below.

The Summary is not intended to identify key or essential features of the claimed subject matter and also is not intended to be used in isolation to determine the scope of the claimed subject matter. Instead, the claimed subject matter should be understood by reference to appropriate portions of the Specification and drawings, as well as to each claim.

In some embodiments, the present invention provides a composite board, comprising: a core; and a capstock positioned to at least partially cover the core, wherein the capstock comprises: 10 wt. % to 70 wt. % of polyvinyl chloride (PVC), based on a total weight of the capstock, 1 wt. % to 60 wt. % of acrylonitrile-styrene-acrylate (ASA), based on the total weight of the capstock, 1 wt. % to 60 wt. % of styrene-acrylonitrile (SAN), based on the total weight of the capstock, and 1 wt. % to 60 wt. % of a thermoplastic elastomer, wherein the thermoplastic elastomer does not include thermoplastic polyurethane.

In some embodiments, the thermoplastic elastomer includes a block copolymer. In some examples, thermoplastic elastomer may include a block copolymer having alternating hard segments formed from polyester and soft segments formed from polyether or polyester.

In some embodiments, the thermoplastic elastomer comprises at least one of styrene-isobutylene-styrene (SIBS), a thermoplastic copolyester elastomer or combinations thereof.

In some embodiments, the thermoplastic copolyester elastomer comprises a thermoplastic ether ester elastomer.

In some embodiments, the capstock comprises 5 wt. % to 30 wt. % of the thermoplastic elastomer.

In some embodiments, the capstock further comprises: 30 wt. % to 50 wt. % of PVC, 20 wt. % to 40 wt. % of ASA, and 10 wt. % to 30 wt. % of SAN.

In some embodiments, the capstock further comprises at least one of a colorant, pigment, plasticizer, lubricant, ultraviolet (UV) stabilizer, light stabilizer, thermal stabilizer, antioxidant (AO), antistatic agent, flame retardant, filler, fiber, processing aid, biocide, surfactant, blowing agent, foaming agent, wax, and/or combinations thereof.

In some embodiments, the present invention provides a composite board, comprising: a core; and a capstock positioned to at least partially cover the core, wherein the capstock comprises: 10 wt. % to 70 wt. % of polyvinyl chloride (PVC), based on a total weight of the capstock, 1 wt. % to 60 wt. % of acrylonitrile-styrene-acrylate (ASA), based on the total weight of the capstock, 1 wt. % to 60 wt. % of styrene-acrylonitrile (SAN), based on the total weight of the capstock, and 1 wt. % to 60 wt. % of a polymeric plasticizer, wherein the capstock does not include thermoplastic polyurethane.

In some embodiments, the polymeric plasticizer comprises a terpolymer.

In some embodiments, the terpolymer comprises a ketone ethylene ester terpolymer.

In some embodiments, the capstock comprises 5 wt. % to 30 wt. % of the polymeric plasticizer.

In some embodiments, the capstock further comprises: 30 wt. % to 50 wt. % of PVC, 20 wt. % to 40 wt. % of ASA, and 10 wt. % to 30 wt. % of SAN.

In some embodiments, the capstock further comprises at least one of a colorant, pigment, plasticizer, lubricant, ultraviolet (UV) stabilizer, light stabilizer, thermal stabilizer, antioxidant (AO), antistatic agent, flame retardant, filler, fiber, processing aid, biocide, surfactant, blowing agent, foaming agent, wax, and/or combinations thereof.

In some embodiments, the present invention provides a method comprising: coextruding a capstock with a core, thereby to form a composite board, wherein the capstock comprises: 10 wt. % to 70 wt. % of polyvinyl chloride (PVC), based on a total weight of the capstock, 1 wt. % to 60 wt. % of acrylonitrile-styrene-acrylate (ASA), based on the total weight of the capstock, 1 wt. % to 60 wt. % of styrene-acrylonitrile (SAN), based on the total weight of the capstock, and 1 wt. % to 60 wt. % of at least one of styrene-isobutylene-styrene (SIBS), a thermoplastic copolyester elastomer, a polymeric plasticizer, or combinations thereof, wherein the capstock does not include thermoplastic polyurethane.

In some embodiments, the thermoplastic copolyester elastomer comprises a thermoplastic ether ester elastomer.

In some embodiments, the capstock further comprises: 30 wt. % to 50 wt. % of PVC, 20 wt. % to 40 wt. % of ASA, and 10 wt. % to 30 wt. % of SAN.

In some embodiments, the capstock further comprises at least one of a colorant, pigment, plasticizer, lubricant, ultraviolet (UV) stabilizer, light stabilizer, thermal stabilizer, antioxidant (AO), antistatic agent, flame retardant, filler, fiber, processing aid, biocide, surfactant, blowing agent, foaming agent, wax, and/or combinations thereof.

### BRIEF DESCRIPTION OF THE FIGURES

This section refers to the drawings that form a part of this disclosure, and which illustrate some of the embodiments of structure, materials, and/or methods of the present invention described herein.

FIG. 1 is a schematic cross-sectional view of a building material, in accordance with some embodiments.

FIG. 2 is a block diagram of a method of forming the building material, in accordance with some embodiments.

FIG. 3 is a schematic diagram of a block copolymer having alternating hard and soft segments according to some embodiments.

In some examples, a thermoplastic elastomer may include a block copolymer having alternating hard segments formed from polyester and soft segments formed from polyether or polyester.

FIG. 4 is a graph of torque versus time for example capstock compositions measured using a torque rheometer in accordance with some embodiments.

FIG. 5 is a plot showing Taber abrasion data for example capstock materials according to some embodiments.

FIG. 6 is a plot showing moisture whitening behavior for example capstock materials according to some embodiments.

FIG. 7 is a plot showing surface hardness data for composite articles having a capstock layer formed from example capstock materials according to some embodiments.

FIG. 8 is a plot showing specific gravity data for example capstock compositions according to some embodiments.

FIG. 9 is a plot showing surface gloss for composite articles having a capstock layer formed from example capstock materials according to some embodiments.

### DETAILED DESCRIPTION

In addition to the benefits and improvements that the Specification discloses, other objects and advantages that the Specification provides will become apparent from the following description taken in conjunction with the accompanying figures. Although the description discloses and describes detailed embodiments of the present disclosure, the disclosed embodiments are merely illustrative of the disclosure that may be embodied in various forms. In addition, each of the examples given regarding the various embodiments of the disclosure are intended to be illustrative, and not restrictive.

As used herein, the phrases “in an embodiment,” “in some embodiments,” and any similar phrase, as used herein, do not necessarily refer to the same embodiment or embodiments, though the phrases may refer to the same embodiment or embodiments. Furthermore, the phrases “in another embodiment,” and any similar phrase, as used herein, do not necessarily refer to a different embodiment, although the phrases may refer to a different embodiment. All embodiments of the disclosure are intended to be combinable without departing from the scope or spirit of the disclosure.

As used herein, terms such as “comprising,” “including,” “having,” “with,” and any similar phrase or phrases, do not limit the scope of a specific claim to the materials or steps recited by the claim.

In some embodiments, the present invention includes a building material. In some embodiments, the building material includes a decking material. In some embodiments, the building material includes a board. In some embodiments, the building material includes a composite decking material. In some embodiments, the building material includes a composite board. In some embodiments, the building material includes a core and a capstock. In some embodiments, the capstock at least partially covers at least one surface of the core. In some embodiments, the capstock covers at least one surface of the core. In some embodiments, the capstock covers multiple surfaces of the core.

In some embodiments, the capstock includes a halogen-containing polymer. In some embodiments, the halogen-containing polymer includes polyvinyl chloride (PVC).

In some embodiments, the capstock includes an acrylic polymer. In some embodiments, the acrylic polymer includes acrylonitrile-styrene-acrylate (ASA).

In some embodiments, the capstock includes styrene-acrylonitrile (SAN).

In some embodiments, the capstock includes two or more of a halogen-containing polymer, an acrylic polymer, and/or SAN. In some embodiments, the capstock includes a halogen-containing polymer, an acrylic polymer, and SAN.

In some embodiments, the capstock includes two or more of PVC, ASA, and/or SAN. In some embodiments, the capstock includes PVC, ASA, and SAN.

In some embodiments, the capstock includes a thermoplastic elastomer, and one or more of PVC, ASA, and/or SAN. In some embodiments, the capstock includes a thermoplastic elastomer, and one or more of PVC, ASA, and/or SAN. In some embodiments, the thermoplastic elastomer includes a thermoplastic copolymer elastomer. In some embodiments, the thermoplastic elastomer does not include thermoplastic polyurethane (TPU). In some embodiments, the thermoplastic elastomer does not include an aliphatic polyether-based TPU. In some embodiments, the thermoplastic elastomer includes TPU and another thermoplastic elastomer.

In some embodiments, the thermoplastic elastomer includes styrene-isobutylene-styrene (SIBS). In some embodiments, the thermoplastic elastomer includes SIBS and styrene-isobutylene (SIB). In some embodiments, the thermoplastic elastomer includes a tri-block type SIBS. In some embodiments, the thermoplastic elastomer includes a di-block type SIB. In some embodiments, the thermoplastic elastomer includes a tri-block type SIBS and a di-block type SIB.

In some embodiments, the thermoplastic elastomer includes a thermoplastic copolyester elastomer. In some embodiments, the thermoplastic elastomer includes a thermoplastic ether ester elastomer.

In some embodiments, the thermoplastic elastomer comprises a block copolymer. In some examples, thermoplastic elastomer may include a block copolymer having alternating hard segments formed from polyester and soft segments formed from polyether or polyester.

In some embodiments, the capstock does not include TPU, and includes one or more of the above-identified thermoplastic elastomers. In some embodiments, the capstock includes one or more of the above-identified thermoplastic elastomers in addition to TPU.

In some embodiments, the capstock consists essentially of PVC, ASA, SAN, and a thermoplastic elastomer other than TPU. In some embodiments, the capstock consists essentially of PVC, ASA, SAN, and a thermoplastic elastomer other than TPU, and one or more of a colorant, pigment, plasticizer, lubricant, ultraviolet (UV) stabilizer, light stabilizer, thermal stabilizer, antioxidant (AO), antistatic agent, flame retardant, filler, fiber, processing aid, biocide, surfactant, blowing agent, foaming agent, wax, and/or combinations thereof.

### Halogen-Containing Polymers

As stated, in some embodiments, the capstock includes a halogen-containing polymer. As a thermoplastic matrix polymer, in some embodiments, the halogen-containing polymer includes one or more of PVC, polyvinyl fluoride, polyvinyl bromide, polyvinylidene chloride, chlorinated polyvinyl chloride, polyvinylidene fluoride, and polyvinylidene bromide, and combinations thereof.

In some embodiments, the capstock includes 10 wt. % to 70 wt. % of the halogen-containing polymer. In some embodiments, the capstock includes 15 wt. % to 70 wt. % of the halogen-containing polymer. In some embodiments, the capstock includes 20 wt. % to 70 wt. % of the halogen-containing polymer. In some embodiments, the capstock includes 25 wt. % to 70 wt. % of the halogen-containing polymer. In some embodiments, the capstock includes 30 wt. % to 70 wt. % of the halogen-containing polymer. In some embodiments, the capstock includes 35 wt. % to 70 wt. % of the halogen-containing polymer. In some embodiments, the capstock includes 40 wt. % to 70 wt. % of the halogen-containing polymer. In some embodiments, the capstock includes 45 wt. % to 70 wt. % of the halogen-containing polymer. In some embodiments, the capstock includes 50 wt. % to 70 wt. % of the halogen-containing polymer. In some embodiments, the capstock includes 55 wt. % to 70 wt. % of the halogen-containing polymer. In some embodiments, the capstock includes 60 wt. % to 70 wt. % of the halogen-containing polymer. In some embodiments, the capstock includes 65 wt. % to 70 wt. % of the halogen-containing polymer.

In some embodiments, the capstock includes 10 wt. % to 65 wt. % of the halogen-containing polymer. In some embodiments, the capstock includes 15 wt. % to 65 wt. % of the halogen-containing polymer. In some embodiments, the capstock includes 20 wt. % to 65 wt. % of the halogen-containing polymer. In some embodiments, the capstock includes 25 wt. % to 65 wt. % of the halogen-containing polymer. In some embodiments, the capstock includes 30 wt. % to 65 wt. % of the halogen-containing polymer. In some embodiments, the capstock includes 35 wt. % to 65 wt. % of the halogen-containing polymer. In some embodiments, the capstock includes 40 wt. % to 65 wt. % of the halogen-containing polymer. In some embodiments, the capstock includes 45 wt. % to 65 wt. % of the halogen-containing polymer. In some embodiments, the capstock includes 50 wt. % to 65 wt. % of the halogen-containing polymer. In some embodiments, the capstock includes 55 wt. % to 65 wt. % of the halogen-containing polymer. In some embodiments, the capstock includes 60 wt. % to 65 wt. % of the halogen-containing polymer.

In some embodiments, the capstock includes 10 wt. % to 60 wt. % of the halogen-containing polymer. In some embodiments, the capstock includes 15 wt. % to 60 wt. % of the halogen-containing polymer. In some embodiments, the capstock includes 20 wt. % to 60 wt. % of the halogen-containing polymer. In some embodiments, the capstock includes 25 wt. % to 60 wt. % of the halogen-containing polymer. In some embodiments, the capstock includes 30 wt. % to 60 wt. % of the halogen-containing polymer. In some embodiments, the capstock includes 35 wt. % to 60 wt. % of the halogen-containing polymer. In some embodiments, the capstock includes 40 wt. % to 60 wt. % of the halogen-containing polymer. In some embodiments, the capstock includes 45 wt. % to 60 wt. % of the halogen-containing polymer. In some embodiments, the capstock includes 50 wt. % to 60 wt. % of the halogen-containing polymer. In some embodiments, the capstock includes 55 wt. % to 60 wt. % of the halogen-containing polymer.

In some embodiments, the capstock includes 10 wt. % to 55 wt. % of the halogen-containing polymer. In some embodiments, the capstock includes 15 wt. % to 55 wt. % of the halogen-containing polymer. In some embodiments, the capstock includes 20 wt. % to 55 wt. % of the halogen-containing polymer. In some embodiments, the capstock includes 25 wt. % to 55 wt. % of the halogen-containing polymer. In some embodiments, the capstock includes 30 wt. % to 55 wt. % of the halogen-containing polymer. In some embodiments, the capstock includes 35 wt. % to 55 wt. % of the halogen-containing polymer. In some embodiments, the capstock includes 40 wt. % to 55 wt. % of the halogen-containing polymer. In some embodiments, the capstock includes 45 wt. % to 55 wt. % of the halogen-containing polymer. In some embodiments, the capstock includes 50 wt. % to 55 wt. % of the halogen-containing polymer.

In some embodiments, the capstock includes 10 wt. % to 50 wt. % of the halogen-containing polymer. In some embodiments, the capstock includes 15 wt. % to 50 wt. % of the halogen-containing polymer. In some embodiments, the capstock includes 20 wt. % to 50 wt. % of the halogen-containing polymer. In some embodiments, the capstock includes 25 wt. % to 50 wt. % of the halogen-containing polymer. In some embodiments, the capstock includes 30 wt. % to 50 wt. % of the halogen-containing polymer. In some embodiments, the capstock includes 35 wt. % to 50 wt. % of the halogen-containing polymer. In some embodiments, the capstock includes 40 wt. % to 50 wt. % of the halogen-containing polymer. In some embodiments, the capstock includes 45 wt. % to 50 wt. % of the halogen-containing polymer.

In some embodiments, the capstock includes 10 wt. % to 45 wt. % of the halogen-containing polymer. In some embodiments, the capstock includes 15 wt. % to 45 wt. % of the halogen-containing polymer. In some embodiments, the capstock includes 20 wt. % to 45 wt. % of the halogen-containing polymer. In some embodiments, the capstock includes 25 wt. % to 45 wt. % of the halogen-containing polymer. In some embodiments, the capstock includes 30 wt. % to 45 wt. % of the halogen-containing polymer. In some embodiments, the capstock includes 35 wt. % to 45 wt. % of the halogen-containing polymer. In some embodiments, the capstock includes 40 wt. % to 45 wt. % of the halogen-containing polymer.

In some embodiments, the capstock includes 10 wt. % to 40 wt. % of the halogen-containing polymer. In some embodiments, the capstock includes 15 wt. % to 40 wt. % of the halogen-containing polymer. In some embodiments, the capstock includes 20 wt. % to 40 wt. % of the halogen-containing polymer. In some embodiments, the capstock includes 25 wt. % to 40 wt. % of the halogen-containing polymer. In some embodiments, the capstock includes 30 wt. % to 40 wt. % of the halogen-containing polymer. In some embodiments, the capstock includes 35 wt. % to 40 wt. % of the halogen-containing polymer.

In some embodiments, the capstock includes 10 wt. % to 35 wt. % of the halogen-containing polymer. In some embodiments, the capstock includes 15 wt. % to 35 wt. % of the halogen-containing polymer. In some embodiments, the capstock includes 20 wt. % to 35 wt. % of the halogen-containing polymer. In some embodiments, the capstock includes 25 wt. % to 35 wt. % of the halogen-containing polymer. In some embodiments, the capstock includes 30 wt. % to 35 wt. % of the halogen-containing polymer.

In some embodiments, the capstock includes 10 wt. % to 30 wt. % of the halogen-containing polymer. In some embodiments, the capstock includes 15 wt. % to 30 wt. % of the halogen-containing polymer. In some embodiments, the capstock includes 20 wt. % to 30 wt. % of the halogen-containing polymer. In some embodiments, the capstock includes 25 wt. % to 30 wt. % of the halogen-containing polymer.

In some embodiments, the capstock includes 10 wt. % to 25 wt. % of the halogen-containing polymer. In some embodiments, the capstock includes 15 wt. % to 25 wt. % of the halogen-containing polymer. In some embodiments, the capstock includes 20 wt. % to 25 wt. % of the halogen-containing polymer.

In some embodiments, the capstock includes 10 wt. % to 20 wt. % of the halogen-containing polymer. In some embodiments, the capstock includes 15 wt. % to 20 wt. % of the halogen-containing polymer. In some embodiments, the capstock includes 10 wt. % to 15 wt. % of the halogen-containing polymer.

### Acrylic Polymer

As stated, in some embodiments, the capstock includes an acrylic polymer as a thermoplastic matrix polymer. In some embodiments, the acrylic polymer includes one or more of ASA, styrene-acrylonitrile, cross-linked acrylonitrile, high molecular weight styrene-acrylonitrile, and/or ultra-high-molecular weight styrene-acrylonitrile, and/or combinations thereof.

In some embodiments, ASA includes a styrene including one or more of a vinyl aromatic monomer, an alkyl styrene, such as alpha-methylstyrene, and/or a ring-alkylated styrenes, such as p-methylstyrene, and/or combinations thereof.

In some embodiments, the capstock includes 1 wt. % to 60 wt. % of the acrylic polymer. In some embodiments, the capstock includes 2 wt. % to 60 wt. % of the acrylic polymer. In some embodiments, the capstock includes 3 wt. % to 60 wt. % of the acrylic polymer. In some embodiments, the capstock includes 4 wt. % to 60 wt. % of the acrylic polymer. In some embodiments, the capstock includes 5 wt. % to 60 wt. % of the acrylic polymer. In some embodiments, the capstock includes 10 wt. % to 60 wt. % of the acrylic polymer. In some embodiments, the capstock includes 15 wt. % to 60 wt. % of the acrylic polymer. In some embodiments, the capstock includes 20 wt. % to 60 wt. % of the acrylic polymer. In some embodiments, the capstock includes 25 wt. % to 60 wt. % of the acrylic polymer. In some embodiments, the capstock includes 30 wt. % to 60 wt. % of the acrylic polymer. In some embodiments, the capstock includes 35 wt. % to 60 wt. % of the acrylic polymer. In some embodiments, the capstock includes 40 wt. % to 60 wt. % of the acrylic polymer. In some embodiments, the capstock includes 45 wt. % to 60 wt. % of the acrylic polymer. In some embodiments, the capstock includes 50 wt. % to 60 wt. % of the acrylic polymer. In some embodiments, the capstock includes 55 wt. % to 60 wt. % of the acrylic polymer.

In some embodiments, a weight percent is 1 wt. % to 55 wt. % of the acrylic polymer. In some embodiments, the capstock includes 2 wt. % to 55 wt. % of the acrylic polymer. In some embodiments, the capstock includes 3 wt. % to 55 wt. % of the acrylic polymer. In some embodiments, the capstock includes 4 wt. % to 55 wt. % of the acrylic polymer. In some embodiments, the capstock includes 5 wt. % to 55 wt. % of the acrylic polymer. In some embodiments, the capstock includes 10 wt. % to 55 wt. % of the acrylic polymer. In some embodiments, the capstock includes 15 wt. % to 55 wt. % of the acrylic polymer. In some embodiments, the capstock includes 20 wt. % to 55 wt. % of the acrylic polymer. In some embodiments, the capstock includes 25 wt. % to 55 wt. % of the acrylic polymer. In some embodiments, the capstock includes 30 wt. % to 55 wt. % of the acrylic polymer. In some embodiments, the capstock includes 35 wt. % to 55 wt. % of the acrylic polymer. In some embodiments, the capstock includes 40 wt. % to 55 wt. % of the acrylic polymer. In some embodiments, the capstock includes 45 wt. % to 55 wt. % of the acrylic polymer. In some embodiments, the capstock includes 50 wt. % to 55 wt. % of the acrylic polymer.

In some embodiments, a weight percent is 1 wt. % to 50 wt. % of the acrylic polymer. In some embodiments, the capstock includes 2 wt. % to 50 wt. % of the acrylic polymer. In some embodiments, the capstock includes 3 wt. % to 50 wt. % of the acrylic polymer. In some embodiments, the capstock includes 4 wt. % to 50 wt. % of the acrylic polymer. In some embodiments, the capstock includes 5 wt. % to 50 wt. % of the acrylic polymer. In some embodiments, the capstock includes 10 wt. % to 50 wt. % of the acrylic polymer. In some embodiments, the capstock includes 15 wt. % to 50 wt. % of the acrylic polymer. In some embodiments, the capstock includes 20 wt. % to 50 wt. % of the acrylic polymer. In some embodiments, the capstock includes 25 wt. % to 50 wt. % of the acrylic polymer. In some embodiments, the capstock includes 30 wt. % to 50 wt. % of the acrylic polymer. In some embodiments, the capstock includes 35 wt. % to 50 wt. % of the acrylic polymer. In some embodiments, the capstock includes 40 wt. % to 50 wt. % of the acrylic polymer. In some embodiments, the capstock includes 45 wt. % to 50 wt. % of the acrylic polymer.

In some embodiments, the capstock includes 1 wt. % to 45 wt. % of the acrylic polymer. In some embodiments, the capstock includes 2 wt. % to 45 wt. % of the acrylic polymer. In some embodiments, the capstock includes 3 wt. % to 45 wt. % of the acrylic polymer. In some embodiments, the capstock includes 4 wt. % to 45 wt. % of the acrylic polymer. In some embodiments, the capstock includes 5 wt. % to 45 wt. % of the acrylic polymer. In some embodiments, the capstock includes 10 wt. % to 45 wt. % of the acrylic polymer. In some embodiments, the capstock includes 15 wt. % to 45 wt. % of the acrylic polymer. In some embodiments, the capstock includes 20 wt. % to 45 wt. % of the acrylic polymer. In some embodiments, the capstock includes 25 wt. % to 45 wt. % of the acrylic polymer. In some embodiments, the capstock includes 30 wt. % to 45 wt. % of the acrylic polymer. In some embodiments, the capstock includes 35 wt. % to 45 wt. % of the acrylic polymer. In some embodiments, the capstock includes 40 wt. % to 45 wt. % of the acrylic polymer.

In some embodiments, the capstock includes 1 wt. % to 40 wt. % of the acrylic polymer. In some embodiments, the capstock includes 2 wt. % to 40 wt. % of the acrylic polymer. In some embodiments, the capstock includes 3 wt. % to 40 wt. % of the acrylic polymer. In some embodiments, the capstock includes 4 wt. % to 40 wt. % of the acrylic polymer. In some embodiments, the capstock includes 5 wt. % to 40 wt. % of the acrylic polymer. In some embodiments, the capstock includes 10 wt. % to 40 wt. % of the acrylic polymer. In some embodiments, the capstock includes 15 wt. % to 40 wt. % of the acrylic polymer. In some embodiments, the capstock includes 20 wt. % to 40 wt. % of the acrylic polymer. In some embodiments, the capstock includes 25 wt. % to 40 wt. % of the acrylic polymer. In some embodiments, the capstock includes 30 wt. % to 40 wt. % of the acrylic polymer. In some embodiments, the capstock includes 35 wt. % to 40 wt. % of the acrylic polymer.

In some embodiments, the capstock includes 1 wt. % to 35 wt. % of the acrylic polymer. In some embodiments, the capstock includes 2 wt. % to 35 wt. % of the acrylic polymer. In some embodiments, the capstock includes 3 wt. % to 35 wt. % of the acrylic polymer. In some embodiments, the capstock includes 4 wt. % to 35 wt. % of the acrylic polymer. In some embodiments, the capstock includes 5 wt. % to 35 wt. % of the acrylic polymer. In some embodiments, the capstock includes 10 wt. % to 35 wt. % of the acrylic polymer. In some embodiments, the capstock includes 15 wt. % to 35 wt. % of the acrylic polymer. In some embodiments, the capstock includes 20 wt. % to 35 wt. % of the acrylic polymer. In some embodiments, the capstock includes 25 wt. % to 35 wt. % of the acrylic polymer. In some embodiments, the capstock includes 30 wt. % to 35 wt. % of the acrylic polymer.

In some embodiments, the capstock includes 1 wt. % to 30 wt. % of the acrylic polymer. In some embodiments, the capstock includes 2 wt. % to 30 wt. % of the acrylic polymer. In some embodiments, the capstock includes 3 wt. % to 30 wt. % of the acrylic polymer. In some embodiments, the capstock includes 4 wt. % to 30 wt. % of the acrylic polymer. In some embodiments, the capstock includes 5 wt. % to 30 wt. % of the acrylic polymer. In some embodiments, the capstock includes 10 wt. % to 30 wt. % of the acrylic polymer. In some embodiments, the capstock includes 15 wt. % to 30 wt. % of the acrylic polymer. In some embodiments, the capstock includes 20 wt. % to 30 wt. % of the acrylic polymer. In some embodiments, the capstock includes 25 wt. % to 30 wt. % of the acrylic polymer.

In some embodiments, the capstock includes 1 wt. % to 25 wt. % of the acrylic polymer. In some embodiments, the capstock includes 2 wt. % to 25 wt. % of the acrylic polymer. In some embodiments, the capstock includes 3 wt. % to 25 wt. % of the acrylic polymer. In some embodiments, the capstock includes 4 wt. % to 25 wt. % of the acrylic polymer. In some embodiments, the capstock includes 5 wt. % to 25 wt. % of the acrylic polymer. In some embodiments, the capstock includes 10 wt. % to 25 wt. % of the acrylic polymer. In some embodiments, the capstock includes 15 wt. % to 25 wt. % of the acrylic polymer. In some embodiments, the capstock includes 20 wt. % to 25 wt. % of the acrylic polymer.

In some embodiments, the capstock includes 1 wt. % to 20 wt. % of the acrylic polymer. In some embodiments, the capstock includes 2 wt. % to 20 wt. % of the acrylic polymer. In some embodiments, the capstock includes 3 wt. % to 20 wt. % of the acrylic polymer. In some embodiments, the capstock includes 4 wt. % to 20 wt. % of the acrylic polymer. In some embodiments, the capstock includes 5 wt. % to 20 wt. % of the acrylic polymer. In some embodiments, the capstock includes 10 wt. % to 20 wt. % of the acrylic polymer. In some embodiments, the capstock includes 15 wt. % to 20 wt. % of the acrylic polymer.

In some embodiments, the capstock includes 1 wt. % to 15 wt. % of the acrylic polymer. In some embodiments, the capstock includes 2 wt. % to 15 wt. % of the acrylic polymer. In some embodiments, the capstock includes 3 wt. % to 15 wt. % of the acrylic polymer. In some embodiments, the capstock includes 4 wt. % to 15 wt. % of the acrylic polymer. In some embodiments, the capstock includes 5 wt. % to 15 wt. % of the acrylic polymer. In some embodiments, the capstock includes 10 wt. % to 15 wt. % of the acrylic polymer.

In some embodiments, the capstock includes 1 wt. % to 10 wt. % of the acrylic polymer. In some embodiments, the capstock includes 2 wt. % to 10 wt. % of the acrylic polymer. In some embodiments, the capstock includes 3 wt. % to 10 wt. % of the acrylic polymer. In some embodiments, the capstock includes 4 wt. % to 10 wt. % of the acrylic polymer. In some embodiments, the capstock includes 5 wt. % to 10 wt. % of the acrylic polymer.

In some embodiments, the capstock includes 1 wt. % to 5 wt. % of the acrylic polymer. In some embodiments, the capstock includes 2 wt. % to 5 wt. % of the acrylic polymer. In some embodiments, the capstock includes 3 wt. % to 5 wt. % of the acrylic polymer. In some embodiments, the capstock includes 4 wt. % to 5 wt. % of the acrylic polymer.

In some embodiments, the capstock includes 1 wt. % to 4 wt. % of the acrylic polymer. In some embodiments, the capstock includes 2 wt. % to 4 wt. % of the acrylic polymer. In some embodiments, the capstock includes 3 wt. % to 4 wt. % of the acrylic polymer.

In some embodiments, the capstock includes 1 wt. % to 3 wt. % of the acrylic polymer. In some embodiments, the capstock includes 2 wt. % to 3 wt. % of the acrylic polymer. In some embodiments, the capstock includes 1 wt. % to 2 wt. % of the acrylic polymer.

In some embodiments, the weight percent of the acrylic polymer in the capstock is 1 wt. % to 60 wt. % of the acrylic polymer. In some embodiments, the capstock includes 2 wt. % to 60 wt. % of the acrylic polymer. In some embodiments, the capstock includes 3 wt. % to 60 wt. % of the acrylic polymer. In some embodiments, the capstock includes 4 wt. % to 60 wt. % of the acrylic polymer. In some embodiments, the capstock includes 5 wt. % to 60 wt. % of the acrylic polymer. In some embodiments, the capstock includes 10 wt. % to 60 wt. % of the acrylic polymer. In some embodiments, the capstock includes 15 wt. % to 60 wt. % of the acrylic polymer. In some embodiments, the capstock includes 20 wt. % to 60 wt. % of the acrylic polymer. In some embodiments, the capstock includes 25 wt. % to 60 wt. % of the acrylic polymer. In some embodiments, the capstock includes 30 wt. % to 60 wt. % of the acrylic polymer. In some embodiments, the capstock includes 35 wt. % to 60 wt. % of the acrylic polymer. In some embodiments, the capstock includes 40 wt. % to 60 wt. % of the acrylic polymer. In some embodiments, the capstock includes 45 wt. % to 60 wt. % of the acrylic polymer. In some embodiments, the capstock includes 50 wt. % to 60 wt. % of the acrylic polymer. In some embodiments, the capstock includes 55 wt. % to 60 wt. % of the acrylic polymer.

In some embodiments, the capstock includes 1 wt. % to 55 wt. % of the acrylic polymer. In some embodiments, the capstock includes 2 wt. % to 55 wt. % of the acrylic polymer. In some embodiments, the capstock includes 3 wt. % to 55 wt. % of the acrylic polymer. In some embodiments, the capstock includes 4 wt. % to 55 wt. % of the acrylic polymer. In some embodiments, the capstock includes 5 wt. % to 55 wt. % of the acrylic polymer. In some embodiments, the capstock includes 10 wt. % to 55 wt. % of the acrylic polymer. In some embodiments, the capstock includes 15 wt. % to 55 wt. % of the acrylic polymer. In some embodiments, the capstock includes 20 wt. % to 55 wt. % of the acrylic polymer. In some embodiments, the capstock includes 25 wt. % to 55 wt. % of the acrylic polymer. In some embodiments, the capstock includes 30 wt. % to 55 wt. % of the acrylic polymer. In some embodiments, the capstock includes 35 wt. % to 55 wt. % of the acrylic polymer. In some embodiments, the capstock includes 40 wt. % to 55 wt. % of the acrylic polymer. In some embodiments, the capstock includes 45 wt. % to 55 wt. % of the acrylic polymer. In some embodiments, the capstock includes 50 wt. % to 55 wt. % of the acrylic polymer.

In some embodiments, the capstock includes 1 wt. % to 50 wt. % of the acrylic polymer. In some embodiments, the capstock includes 2 wt. % to 50 wt. % of the acrylic polymer. In some embodiments, the capstock includes 3 wt. % to 50 wt. % of the acrylic polymer. In some embodiments, the capstock includes 4 wt. % to 50 wt. % of the acrylic polymer. In some embodiments, the capstock includes 5 wt. % to 50 wt. % of the acrylic polymer. In some embodiments, the capstock includes 10 wt. % to 50 wt. % of the acrylic polymer. In some embodiments, the capstock includes 15 wt. % to 50 wt. % of the acrylic polymer. In some embodiments, the capstock includes 20 wt. % to 50 wt. % of the acrylic polymer. In some embodiments, the capstock includes 25 wt. % to 50 wt. % of the acrylic polymer. In some embodiments, the capstock includes 30 wt. % to 50 wt. % of the acrylic polymer. In some embodiments, the capstock includes 35 wt. % to 50 wt. % of the acrylic polymer. In some embodiments, the capstock includes 40 wt. % to 50 wt. % of the acrylic polymer. In some embodiments, the capstock includes 45 wt. % to 50 wt. % of the acrylic polymer.

In some embodiments, the capstock includes 1 wt. % to 45 wt. % of the acrylic polymer. In some embodiments, the capstock includes 2 wt. % to 45 wt. % of the acrylic polymer. In some embodiments, the capstock includes 3 wt. % to 45 wt. % of the acrylic polymer. In some embodiments, the capstock includes 4 wt. % to 45 wt. % of the acrylic polymer. In some embodiments, the capstock includes 5 wt. % to 45 wt. % of the acrylic polymer. In some embodiments, the capstock includes 10 wt. % to 45 wt. % of the acrylic polymer. In some embodiments, the capstock includes 15 wt. % to 45 wt. % of the acrylic polymer. In some embodiments, the capstock includes 20 wt. % to 45 wt. % of the acrylic polymer. In some embodiments, the capstock includes 25 wt. % to 45 wt. % of the acrylic polymer. In some embodiments, the capstock includes 30 wt. % to 45 wt. % of the acrylic polymer. In some embodiments, the capstock includes 35 wt. % to 45 wt. % of the acrylic polymer. In some embodiments, the capstock includes 40 wt. % to 45 wt. % of the acrylic polymer.

In some embodiments, the capstock includes 1 wt. % to 40 wt. % of the acrylic polymer. In some embodiments, the capstock includes 2 wt. % to 40 wt. % of the acrylic polymer. In some embodiments, the capstock includes 3 wt. % to 40 wt. % of the acrylic polymer. In some embodiments, the capstock includes 4 wt. % to 40 wt. % of the acrylic polymer. In some embodiments, the capstock includes 5 wt. % to 40 wt. % of the acrylic polymer. In some embodiments, the capstock includes 10 wt. % to 40 wt. % of the acrylic polymer. In some embodiments, the capstock includes 15 wt. % to 40 wt. % of the acrylic polymer. In some embodiments, the capstock includes 20 wt. % to 40 wt. % of the acrylic polymer. In some embodiments, the capstock includes 25 wt. % to 40 wt. % of the acrylic polymer. In some embodiments, the capstock includes 30 wt. % to 40 wt. % of the acrylic polymer. In some embodiments, the capstock includes 35 wt. % to 40 wt. % of the acrylic polymer.

In some embodiments, the capstock includes 1 wt. % to 35 wt. % of the acrylic polymer. In some embodiments, the capstock includes 2 wt. % to 35 wt. % of the acrylic polymer. In some embodiments, the capstock includes 3 wt. % to 35 wt. % of the acrylic polymer. In some embodiments, the capstock includes 4 wt. % to 35 wt. % of the acrylic polymer. In some embodiments, the capstock includes 5 wt. % to 35 wt. % of the acrylic polymer. In some embodiments, the capstock includes 10 wt. % to 35 wt. % of the acrylic polymer. In some embodiments, the capstock includes 15 wt. % to 35 wt. % of the acrylic polymer. In some embodiments, the capstock includes 20 wt. % to 35 wt. % of the acrylic polymer. In some embodiments, the capstock includes 25 wt. % to 35 wt. % of the acrylic polymer. In some embodiments, the capstock includes 30 wt. % to 35 wt. % of the acrylic polymer.

In some embodiments, the capstock includes 1 wt. % to 30 wt. % of the acrylic polymer. In some embodiments, the capstock includes 2 wt. % to 30 wt. % of the acrylic polymer. In some embodiments, the capstock includes 3 wt. % to 30 wt. % of the acrylic polymer. In some embodiments, the capstock includes 4 wt. % to 30 wt. % of the acrylic polymer. In some embodiments, the capstock includes 5 wt. % to 30 wt. % of the acrylic polymer. In some embodiments, the capstock includes 10 wt. % to 30 wt. % of the acrylic polymer. In some embodiments, the capstock includes 15 wt. % to 30 wt. % of the acrylic polymer. In some embodiments, the capstock includes 20 wt. % to 30 wt. % of the acrylic polymer. In some embodiments, the capstock includes 25 wt. % to 30 wt. % of the acrylic polymer.

In some embodiments, the capstock includes 1 wt. % to 25 wt. % of the acrylic polymer. In some embodiments, the capstock includes 2 wt. % to 25 wt. % of the acrylic polymer. In some embodiments, the capstock includes 3 wt. % to 25 wt. % of the acrylic polymer. In some embodiments, the capstock includes 4 wt. % to 25 wt. % of the acrylic polymer. In some embodiments, the capstock includes 5 wt. % to 25 wt. % of the acrylic polymer. In some embodiments, the capstock includes 10 wt. % to 25 wt. % of the acrylic polymer. In some embodiments, the capstock includes 15 wt. % to 25 wt. % of the acrylic polymer. In some embodiments, the capstock includes 20 wt. % to 25 wt. % of the acrylic polymer.

In some embodiments, the capstock includes 1 wt. % to 20 wt. % of the acrylic polymer. In some embodiments, the capstock includes 2 wt. % to 20 wt. % of the acrylic polymer. In some embodiments, the capstock includes 3 wt. % to 20 wt. % of the acrylic polymer. In some embodiments, the capstock includes 4 wt. % to 20 wt. % of the acrylic polymer. In some embodiments, the capstock includes 5 wt. % to 20 wt. % of the acrylic polymer. In some embodiments, the capstock includes 10 wt. % to 20 wt. % of the acrylic polymer. In some embodiments, the capstock includes 15 wt. % to 20 wt. % of the acrylic polymer.

In some embodiments, the capstock includes 1 wt. % to 15 wt. % of the acrylic polymer. In some embodiments, the capstock includes 2 wt. % to 15 wt. % of the acrylic polymer. In some embodiments, the capstock includes 3 wt. % to 15 wt. % of the acrylic polymer. In some embodiments, the capstock includes 4 wt. % to 15 wt. % of the acrylic polymer. In some embodiments, the capstock includes 5 wt. % to 15 wt. % of the acrylic polymer. In some embodiments, the capstock includes 10 wt. % to 15 wt. % of the acrylic polymer.

In some embodiments, the capstock includes 1 wt. % to 10 wt. % of the acrylic polymer. In some embodiments, the capstock includes 2 wt. % to 10 wt. % of the acrylic polymer. In some embodiments, the capstock includes 3 wt. % to 10 wt. % of the acrylic polymer. In some embodiments, the capstock includes 4 wt. % to 10 wt. % of the acrylic polymer. In some embodiments, the capstock includes 5 wt. % to 10 wt. % of the acrylic polymer.

In some embodiments, the capstock includes 1 wt. % to 5 wt. % of the acrylic polymer. In some embodiments, the capstock includes 2 wt. % to 5 wt. % of the acrylic polymer. In some embodiments, the capstock includes 3 wt. % to 5 wt. % of the acrylic polymer. In some embodiments, the capstock includes 4 wt. % to 5 wt. % of the acrylic polymer.

In some embodiments, the capstock includes 1 wt. % to 4 wt. % of the acrylic polymer. In some embodiments, the capstock includes 2 wt. % to 4 wt. % of the acrylic polymer. In some embodiments, the capstock includes 3 wt. % to 4 wt. % of the acrylic polymer.

In some embodiments, the capstock includes 1 wt. % to 3 wt. % of the acrylic polymer. In some embodiments, the capstock includes 2 wt. % to 3 wt. % of the acrylic polymer. In some embodiments, the capstock includes 1 wt. % to 2 wt. % of the acrylic polymer.

### Styrene-Acrylonitrile (SAN)

As stated, in some embodiments, the capstock includes SAN as a thermoplastic matrix polymer. In some embodiments, the SAN includes a cross-linked SAN, and/or a high molecular weight SAN. In some embodiments, the SAN includes acrylonitrile.

In some embodiments, the SAN includes 1 wt. % to 60 wt. % a weight percent of acrylonitrile, based on a total weight of the SAN. In some embodiments, the SAN includes 2 wt. % to 60 wt. % of the acrylonitrile. In some embodiments, the SAN includes 3 wt. % to 60 wt. % of the acrylonitrile. In some embodiments, the SAN includes 4 wt. % to 60 wt. % of the acrylonitrile. In some embodiments, the SAN includes 5 wt. % to 60 wt. % of the acrylonitrile. In some embodiments, the SAN includes 10 wt. % to 60 wt. % of the acrylonitrile. In some embodiments, the SAN includes 15 wt. % to 60 wt. % of the acrylonitrile. In some embodiments, the SAN includes 20 wt. % to 60 wt. % of the acrylonitrile. In some embodiments, the SAN includes 25 wt. % to 60 wt. % of the acrylonitrile. In some embodiments, the SAN includes 30 wt. % to 60 wt. % of the acrylonitrile. In some embodiments, the SAN includes 35 wt. % to 60 wt. % of the acrylonitrile. In some embodiments, the SAN includes 40 wt. % to 60 wt. % of the acrylonitrile. In some embodiments, the SAN includes 45 wt. % to 60 wt. % of the acrylonitrile. In some embodiments, the SAN includes 50 wt. % to 60 wt. % of the acrylonitrile. In some embodiments, the SAN includes 55 wt. % to 60 wt. % of the acrylonitrile.

In some embodiments, the SAN includes 1 wt. % to 55 wt. % of the acrylonitrile. In some embodiments, the SAN includes 2 wt. % to 55 wt. % of the acrylonitrile. In some embodiments, the SAN includes 3 wt. % to 55 wt. % of the acrylonitrile. In some embodiments, the SAN includes 4 wt. % to 55 wt. % of the acrylonitrile. In some embodiments, the SAN includes 5 wt. % to 55 wt. % of the acrylonitrile. In some embodiments, the SAN includes 10 wt. % to 55 wt. % of the acrylonitrile. In some embodiments, the SAN includes 15 wt. % to 55 wt. % of the acrylonitrile. In some embodiments, the SAN includes 20 wt. % to 55 wt. % of the acrylonitrile. In some embodiments, the SAN includes 25 wt. % to 55 wt. % of the acrylonitrile. In some embodiments, the SAN includes 30 wt. % to 55 wt. % of the acrylonitrile. In some embodiments, the SAN includes 35 wt. % to 55 wt. % of the acrylonitrile. In some embodiments, the SAN includes 40 wt. % to 55 wt. % of the acrylonitrile. In some embodiments, the SAN includes 45 wt. % to 55 wt. % of the acrylonitrile. In some embodiments, the SAN includes 50 wt. % to 55 wt. % of the acrylonitrile.

In some embodiments, the SAN includes 1 wt. % to 50 wt. % of the acrylonitrile. In some embodiments, the SAN includes 2 wt. % to 50 wt. % of the acrylonitrile. In some embodiments, the SAN includes 3 wt. % to 50 wt. % of the acrylonitrile. In some embodiments, the SAN includes 4 wt. % to 50 wt. % of the acrylonitrile. In some embodiments, the SAN includes 5 wt. % to 50 wt. % of the acrylonitrile. In some embodiments, the SAN includes 10 wt. % to 50 wt. % of the acrylonitrile. In some embodiments, the SAN includes 15 wt. % to 50 wt. % of the acrylonitrile. In some embodiments, the SAN includes 20 wt. % to 50 wt. % of the acrylonitrile. In some embodiments, the SAN includes 25 wt. % to 50 wt. % of the acrylonitrile. In some embodiments, the SAN includes 30 wt. % to 50 wt. % of the acrylonitrile. In some embodiments, the SAN includes 35 wt. % to 50 wt. % of the acrylonitrile. In some embodiments, the SAN includes 40 wt. % to 50 wt. % of the acrylonitrile. In some embodiments, the SAN includes 45 wt. % to 50 wt. % of the acrylonitrile.

In some embodiments, the SAN includes 1 wt. % to 45 wt. % of the acrylonitrile. In some embodiments, the SAN includes 2 wt. % to 45 wt. % of the acrylonitrile. In some embodiments, the SAN includes 3 wt. % to 45 wt. % of the acrylonitrile. In some embodiments, the SAN includes 4 wt. % to 45 wt. % of the acrylonitrile. In some embodiments, the SAN includes 5 wt. % to 45 wt. % of the acrylonitrile. In some embodiments, the SAN includes 10 wt. % to 45 wt. % of the acrylonitrile. In some embodiments, the SAN includes 15 wt. % to 45 wt. % of the acrylonitrile. In some embodiments, the SAN includes 20 wt. % to 45 wt. % of the acrylonitrile. In some embodiments, the SAN includes 25 wt. % to 45 wt. % of the acrylonitrile. In some embodiments, the SAN includes 30 wt. % to 45 wt. % of the acrylonitrile. In some embodiments, the SAN includes 35 wt. % to 45 wt. % of the acrylonitrile. In some embodiments, the SAN includes 40 wt. % to 45 wt. % of the acrylonitrile.

In some embodiments, the SAN includes 1 wt. % to 40 wt. % of the acrylonitrile. In some embodiments, the SAN includes 2 wt. % to 40 wt. % of the acrylonitrile. In some embodiments, the SAN includes 3 wt. % to 40 wt. % of the acrylonitrile. In some embodiments, the SAN includes 4 wt. % to 40 wt. % of the acrylonitrile. In some embodiments, the SAN includes 5 wt. % to 40 wt. % of the acrylonitrile. In some embodiments, the SAN includes 10 wt. % to 40 wt. % of the acrylonitrile. In some embodiments, the SAN includes 15 wt. % to 40 wt. % of the acrylonitrile. In some embodiments, the SAN includes 20 wt. % to 40 wt. % of the acrylonitrile. In some embodiments, the SAN includes 25 wt. % to 40 wt. % of the acrylonitrile. In some embodiments, the SAN includes 30 wt. % to 40 wt. % of the acrylonitrile. In some embodiments, the SAN includes 35 wt. % to 40 wt. % of the acrylonitrile.

In some embodiments, the SAN includes 1 wt. % to 35 wt. % of the acrylonitrile. In some embodiments, the SAN includes 2 wt. % to 35 wt. % of the acrylonitrile. In some embodiments, the SAN includes 3 wt. % to 35 wt. % of the acrylonitrile. In some embodiments, the SAN includes 4 wt. % to 35 wt. % of the acrylonitrile. In some embodiments, the SAN includes 5 wt. % to 35 wt. % of the acrylonitrile. In some embodiments, the SAN includes 10 wt. % to 35 wt. % of the acrylonitrile. In some embodiments, the SAN includes 15 wt. % to 35 wt. % of the acrylonitrile. In some embodiments, the SAN includes 20 wt. % to 35 wt. % of the acrylonitrile. In some embodiments, the SAN includes 25 wt. % to 35 wt. % of the acrylonitrile. In some embodiments, the SAN includes 30 wt. % to 35 wt. % of the acrylonitrile.

In some embodiments, the SAN includes 1 wt. % to 30 wt. % of the acrylonitrile. In some embodiments, the SAN includes 2 wt. % to 30 wt. % of the acrylonitrile. In some embodiments, the SAN includes 3 wt. % to 30 wt. % of the acrylonitrile. In some embodiments, the SAN includes 4 wt. % to 30 wt. % of the acrylonitrile. In some embodiments, the SAN includes 5 wt. % to 30 wt. % of the acrylonitrile. In some embodiments, the SAN includes 10 wt. % to 30 wt. % of the acrylonitrile. In some embodiments, the SAN includes 15 wt. % to 30 wt. % of the acrylonitrile. In some embodiments, the SAN includes 20 wt. % to 30 wt. % of the acrylonitrile. In some embodiments, the SAN includes 25 wt. % to 30 wt. % of the acrylonitrile.

In some embodiments, the SAN includes 1 wt. % to 25 wt. % of the acrylonitrile. In some embodiments, the SAN includes 2 wt. % to 25 wt. % of the acrylonitrile. In some embodiments, the SAN includes 3 wt. % to 25 wt. % of the acrylonitrile. In some embodiments, the SAN includes 4 wt. % to 25 wt. % of the acrylonitrile. In some embodiments, the SAN includes 5 wt. % to 25 wt. % of the acrylonitrile. In some embodiments, the SAN includes 10 wt. % to 25 wt. % of the acrylonitrile. In some embodiments, the SAN includes 15 wt. % to 25 wt. % of the acrylonitrile. In some embodiments, the SAN includes 20 wt. % to 25 wt. % of the acrylonitrile.

In some embodiments, the SAN includes 1 wt. % to 20 wt. % of the acrylonitrile. In some embodiments, the SAN includes 2 wt. % to 20 wt. % of the acrylonitrile. In some embodiments, the SAN includes 3 wt. % to 20 wt. % of the acrylonitrile. In some embodiments, the SAN includes 4 wt. % to 20 wt. % of the acrylonitrile. In some embodiments, the SAN includes 5 wt. % to 20 wt. % of the acrylonitrile. In some embodiments, the SAN includes 10 wt. % to 20 wt. % of the acrylonitrile. In some embodiments, the SAN includes 15 wt. % to 20 wt. % of the acrylonitrile. In some embodiments, the SAN includes 1 wt. % to 15 wt. % of the acrylonitrile.

In some embodiments, the SAN includes 2 wt. % to 15 wt. % of the acrylonitrile. In some embodiments, the SAN includes 3 wt. % to 15 wt. % of the acrylonitrile. In some embodiments, the SAN includes 4 wt. % to 15 wt. % of the acrylonitrile. In some embodiments, the SAN includes 5 wt. % to 15 wt. % of the acrylonitrile. In some embodiments, the SAN includes 10 wt. % to 15 wt. % of the acrylonitrile.

In some embodiments, the SAN includes 1 wt. % to 10 wt. % of the acrylonitrile. In some embodiments, the SAN includes 2 wt. % to 10 wt. % of the acrylonitrile. In some embodiments, the SAN includes 3 wt. % to 10 wt. % of the acrylonitrile. In some embodiments, the SAN includes 4 wt. % to 10 wt. % of the acrylonitrile. In some embodiments, the SAN includes 5 wt. % to 10 wt. % of the acrylonitrile.

In some embodiments, the SAN includes 1 wt. % to 5 wt. % of the acrylonitrile. In some embodiments, the SAN includes 2 wt. % to 5 wt. % of the acrylonitrile. In some embodiments, the SAN includes 3 wt. % to 5 wt. % of the acrylonitrile. In some embodiments, the SAN includes 4 wt. % to 5 wt. % of the acrylonitrile.

In some embodiments, the SAN includes 1 wt. % to 4 wt. % of the acrylonitrile. In some embodiments, the SAN includes 2 wt. % to 4 wt. % of the acrylonitrile. In some embodiments, the SAN includes 3 wt. % to 4 wt. % of the acrylonitrile.

In some embodiments, the SAN includes 1 wt. % to 3 wt. % of the acrylonitrile. In some embodiments, the SAN includes 2 wt. % to 3 wt. % of the acrylonitrile. In some embodiments, the SAN includes 1 wt. % to 2 wt. % of the acrylonitrile.

In some embodiments, the capstock includes 1 wt. % to 60 wt. % of a weight percent of SAN, based on a total weight of the capstock. In some embodiments, the capstock includes 2 wt. % to 60 wt. % of SAN. In some embodiments, the capstock includes 3 wt. % to 60 wt. % of SAN. In some embodiments, the capstock includes 4 wt. % to 60 wt. % of SAN. In some embodiments, the capstock includes 5 wt. % to 60 wt. % of SAN. In some embodiments, the capstock includes 10 wt. % to 60 wt. % of SAN. In some embodiments, the capstock includes 15 wt. % to 60 wt. % of SAN. In some embodiments, the capstock includes 20 wt. % to 60 wt. % of SAN. In some embodiments, the capstock includes 25 wt. % to 60 wt. % of SAN. In some embodiments, the capstock includes 30 wt. % to 60 wt. % of SAN. In some embodiments, the capstock includes 35 wt. % to 60 wt. % of SAN. In some embodiments, the capstock includes 40 wt. % to 60 wt. % of SAN. In some embodiments, the capstock includes 45 wt. % to 60 wt. % of SAN. In some embodiments, the capstock includes 50 wt. % to 60 wt. % of SAN. In some embodiments, the capstock includes 55 wt. % to 60 wt. % of SAN.

In some embodiments, the capstock includes 1 wt. % to 55 wt. % of SAN. In some embodiments, the capstock includes 2 wt. % to 55 wt. % of SAN. In some embodiments, the capstock includes 3 wt. % to 55 wt. % of SAN. In some embodiments, the capstock includes 4 wt. % to 55 wt. % of SAN. In some embodiments, the capstock includes 5 wt. % to 55 wt. % of SAN. In some embodiments, the capstock includes 10 wt. % to 55 wt. % of SAN. In some embodiments, the capstock includes 15 wt. % to 55 wt. % of SAN. In some embodiments, the capstock includes 20 wt. % to 55 wt. % of SAN. In some embodiments, the capstock includes 25 wt. % to 55 wt. % of SAN. In some embodiments, the capstock includes 30 wt. % to 55 wt. % of SAN. In some embodiments, the capstock includes 35 wt. % to 55 wt. % of SAN. In some embodiments, the capstock includes 40 wt. % to 55 wt. % of SAN. In some embodiments, the capstock includes 45 wt. % to 55 wt. % of SAN. In some embodiments, the capstock includes 50 wt. % to 55 wt. % of SAN.

In some embodiments, the capstock includes 1 wt. % to 50 wt. % of SAN. In some embodiments, the capstock includes 2 wt. % to 50 wt. % of SAN. In some embodiments, the capstock includes 3 wt. % to 50 wt. % of SAN. In some embodiments, the capstock includes 4 wt. % to 50 wt. % of SAN. In some embodiments, the capstock includes 5 wt. % to 50 wt. % of SAN. In some embodiments, the capstock includes 10 wt. % to 50 wt. % of SAN. In some embodiments, the capstock includes 15 wt. % to 50 wt. % of SAN. In some embodiments, the capstock includes 20 wt. % to 50 wt. % of SAN. In some embodiments, the capstock includes 25 wt. % to 50 wt. % of SAN. In some embodiments, the capstock includes 30 wt. % to 50 wt. % of SAN. In some embodiments, the capstock includes 35 wt. % to 50 wt. % of SAN. In some embodiments, the capstock includes 40 wt. % to 50 wt. % of SAN. In some embodiments, the capstock includes 45 wt. % to 50 wt. % of SAN.

In some embodiments, the capstock includes 1 wt. % to 45 wt. % of SAN. In some embodiments, the capstock includes 2 wt. % to 45 wt. % of SAN. In some embodiments, the capstock includes 3 wt. % to 45 wt. % of SAN. In some embodiments, the capstock includes 4 wt. % to 45 wt. % of SAN. In some embodiments, the capstock includes 5 wt. % to 45 wt. % of SAN. In some embodiments, the capstock includes 10 wt. % to 45 wt. % of SAN. In some embodiments, the capstock includes 15 wt. % to 45 wt. % of SAN. In some embodiments, the capstock includes 20 wt. % to 45 wt. % of SAN. In some embodiments, the capstock includes 25 wt. % to 45 wt. % of SAN. In some embodiments, the capstock includes 30 wt. % to 45 wt. % of SAN. In some embodiments, the capstock includes 35 wt. % to 45 wt. % of SAN. In some embodiments, the capstock includes 40 wt. % to 45 wt. % of SAN.

In some embodiments, the capstock includes 1 wt. % to 40 wt. % of SAN. In some embodiments, the capstock includes 2 wt. % to 40 wt. % of SAN. In some embodiments, the capstock includes 3 wt. % to 40 wt. % of SAN. In some embodiments, the capstock includes 4 wt. % to 40 wt. % of SAN. In some embodiments, the capstock includes 5 wt. % to 40 wt. % of SAN. In some embodiments, the capstock includes 10 wt. % to 40 wt. % of SAN. In some embodiments, the capstock includes 15 wt. % to 40 wt. % of SAN. In some embodiments, the capstock includes 20 wt. % to 40 wt. % of SAN. In some embodiments, the capstock includes 25 wt. % to 40 wt. % of SAN. In some embodiments, the capstock includes 30 wt. % to 40 wt. % of SAN. In some embodiments, the capstock includes 35 wt. % to 40 wt. % of SAN.

In some embodiments, the capstock includes 1 wt. % to 35 wt. % of SAN. In some embodiments, the capstock includes 2 wt. % to 35 wt. % of SAN. In some embodiments, the capstock includes 3 wt. % to 35 wt. % of SAN. In some embodiments, the capstock includes 4 wt. % to 35 wt. % of SAN. In some embodiments, the capstock includes 5 wt. % to 35 wt. % of SAN. In some embodiments, the capstock includes 10 wt. % to 35 wt. % of SAN. In some embodiments, the capstock includes 15 wt. % to 35 wt. % of SAN. In some embodiments, the capstock includes 20 wt. % to 35 wt. % of SAN. In some embodiments, the capstock includes 25 wt. % to 35 wt. % of SAN. In some embodiments, the capstock includes 30 wt. % to 35 wt. % of SAN. In some embodiments, the capstock includes 1 wt. % to 30 wt. % of SAN. In some embodiments, the capstock includes 2 wt. % to 30 wt. % of SAN. In some embodiments, the capstock includes 3 wt. % to 30 wt. % of SAN. In some embodiments, the capstock includes 4 wt. % to 30 wt. % of SAN. In some embodiments, the capstock includes 5 wt. % to 30 wt. % of SAN. In some embodiments, the capstock includes 10 wt. % to 30 wt. % of SAN. In some embodiments, the capstock includes 15 wt. % to 30 wt. % of SAN. In some embodiments, the capstock includes 20 wt. % to 30 wt. % of SAN. In some embodiments, the capstock includes 25 wt. % to 30 wt. % of SAN.

In some embodiments, the capstock includes 1 wt. % to 25 wt. % of SAN. In some embodiments, the capstock includes 2 wt. % to 25 wt. % of SAN. In some embodiments, the capstock includes 3 wt. % to 25 wt. % of SAN. In some embodiments, the capstock includes 4 wt. % to 25 wt. % of SAN. In some embodiments, the capstock includes 5 wt. % to 25 wt. % of SAN. In some embodiments, the capstock includes 10 wt. % to 25 wt. % of SAN. In some embodiments, the capstock includes 15 wt. % to 25 wt. % of SAN. In some embodiments, the capstock includes 20 wt. % to 25 wt. % of SAN.

In some embodiments, the capstock includes 1 wt. % to 20 wt. % of SAN. In some embodiments, the capstock includes 2 wt. % to 20 wt. % of SAN. In some embodiments, the capstock includes 3 wt. % to 20 wt. % of SAN. In some embodiments, the capstock includes 4 wt. % to 20 wt. % of SAN. In some embodiments, the capstock includes 5 wt. % to 20 wt. % of SAN. In some embodiments, the capstock includes 10 wt. % to 20 wt. % of SAN. In some embodiments, the capstock includes 15 wt. % to 20 wt. % of SAN.

In some embodiments, the capstock includes 1 wt. % to 15 wt. % of SAN. In some embodiments, the capstock includes 2 wt. % to 15 wt. % of SAN. In some embodiments, the capstock includes 3 wt. % to 15 wt. % of SAN. In some embodiments, the capstock includes 4 wt. % to 15 wt. % of SAN. In some embodiments, the capstock includes 5 wt. % to 15 wt. % of SAN. In some embodiments, the capstock includes 10 wt. % to 15 wt. % of SAN.

In some embodiments, the capstock includes 1 wt. % to 10 wt. % of SAN. In some embodiments, the capstock includes 2 wt. % to 10 wt. % of SAN. In some embodiments, the capstock includes 3 wt. % to 10 wt. % of SAN. In some embodiments, the capstock includes 4 wt. % to 10 wt. % of SAN. In some embodiments, the capstock includes 5 wt. % to 10 wt. % of SAN.

In some embodiments, the capstock includes 1 wt. % to 5 wt. % of SAN. In some embodiments, the capstock includes 2 wt. % to 5 wt. % of SAN. In some embodiments, the capstock includes 3 wt. % to 5 wt. % of SAN. In some embodiments, the capstock includes 4 wt. % to 5 wt. % of SAN.

In some embodiments, the capstock includes 1 wt. % to 4 wt. % of SAN. In some embodiments, the capstock includes 2 wt. % to 4 wt. % of SAN. In some embodiments, the capstock includes 3 wt. % to 4 wt. % of SAN.

In some embodiments, the capstock includes 1 wt. % to 3 wt. % of SAN. In some embodiments, the capstock includes 2 wt. % to 3 wt. % of SAN. In some embodiments, the capstock includes 1 wt. % to 2 wt. % of SAN.

### Thermoplastic Polyurethane (TPU)

According to some embodiments, thermoplastic polyurethane (TPU) is excluded from a capstock composition. According to some embodiments, the capstock includes thermoplastic polyurethane (TPU) and another thermoplastic elastomer other than TPU. In some embodiments, the TPU includes an ether TPU grade and/or an ester TPU grade. In some embodiments, the TPU includes an aliphatic TPU and/or an aromatic TPU.

In some embodiments, the capstock includes 1 wt. % to 50 wt. % of TPU, based on a total weight of the capstock. In some embodiments, the capstock includes 2 wt. % to 50 wt. % of TPU. In some embodiments, the capstock includes 3 wt. % to 50 wt. % of TPU. In some embodiments, the capstock includes 4 wt. % to 50 wt. % of TPU. In some embodiments, the capstock includes 5 wt. % to 50 wt. % of TPU. In some embodiments, the capstock includes 10 wt. % to 50 wt. % of TPU. In some embodiments, the capstock includes 15 wt. % to 50 wt. % of TPU. In some embodiments, the capstock includes 20 wt. % to 50 wt. % of TPU. In some embodiments, the capstock includes 25 wt. % to 50 wt. % of TPU. In some embodiments, the capstock includes 30 wt. % to 50 wt. % of TPU. In some embodiments, the capstock includes 35 wt. % to 50 wt. % of TPU. In some embodiments, the capstock includes 40 wt. % to 50 wt. % of TPU. In some embodiments, the capstock includes 45 wt. % to 50 wt. % of TPU.

In some embodiments, the capstock includes 1 wt. % to 45 wt. % of TPU. In some embodiments, the capstock includes 2 wt. % to 45 wt. % of TPU. In some embodiments, the capstock includes 3 wt. % to 45 wt. % of TPU. In some embodiments, the capstock includes 4 wt. % to 45 wt. % of TPU. In some embodiments, the capstock includes 5 wt. % to 45 wt. % of TPU. In some embodiments, the capstock includes 10 wt. % to 45 wt. % of TPU. In some embodiments, the capstock includes 15 wt. % to 45 wt. % of TPU. In some embodiments, the capstock includes 20 wt. % to 45 wt. % of TPU. In some embodiments, the capstock includes 25 wt. % to 45 wt. % of TPU. In some embodiments, the capstock includes 30 wt. % to 45 wt. % of TPU. In some embodiments, the capstock includes 35 wt. % to 45 wt. % of TPU. In some embodiments, the capstock includes 40 wt. % to 45 wt. % of TPU.

In some embodiments, the capstock includes 1 wt. % to 40 wt. % of TPU. In some embodiments, the capstock includes 2 wt. % to 40 wt. % of TPU. In some embodiments, the capstock includes 3 wt. % to 40 wt. % of TPU. In some embodiments, the capstock includes 4 wt. % to 40 wt. % of TPU. In some embodiments, the capstock includes 5 wt. % to 40 wt. % of TPU. In some embodiments, the capstock includes 10 wt. % to 40 wt. % of TPU. In some embodiments, the capstock includes 15 wt. % to 40 wt. % of TPU. In some embodiments, the capstock includes 20 wt. % to 40 wt. % of TPU. In some embodiments, the capstock includes 25 wt. % to 40 wt. % of TPU. In some embodiments, the capstock includes 30 wt. % to 40 wt. % of TPU. In some embodiments, the capstock includes 35 wt. % to 40 wt. % of TPU.

In some embodiments, the capstock includes 1 wt. % to 35 wt. % of TPU. In some embodiments, the capstock includes 2 wt. % to 35 wt. % of TPU. In some embodiments, the capstock includes 3 wt. % to 35 wt. % of TPU. In some embodiments, the capstock includes 4 wt. % to 35 wt. % of TPU. In some embodiments, the capstock includes 5 wt. % to 35 wt. % of TPU. In some embodiments, the capstock includes 10 wt. % to 35 wt. % of TPU. In some embodiments, the capstock includes 15 wt. % to 35 wt. % of TPU. In some embodiments, the capstock includes 20 wt. % to 35 wt. % of TPU. In some embodiments, the capstock includes 25 wt. % to 35 wt. % of TPU. In some embodiments, the capstock includes 30 wt. % to 35 wt. % of TPU.

In some embodiments, the capstock includes 1 wt. % to 30 wt. % of TPU. In some embodiments, the capstock includes 2 wt. % to 30 wt. % of TPU. In some embodiments, the capstock includes 3 wt. % to 30 wt. % of TPU. In some embodiments, the capstock includes 4 wt. % to 30 wt. % of TPU. In some embodiments, the capstock includes 5 wt. % to 30 wt. % of TPU. In some embodiments, the capstock includes 10 wt. % to 30 wt. % of TPU. In some embodiments, the capstock includes 15 wt. % to 30 wt. % of TPU. In some embodiments, the capstock includes 20 wt. % to 30 wt. % of TPU. In some embodiments, the capstock includes 25 wt. % to 30 wt. % of TPU.

In some embodiments, the capstock includes 1 wt. % to 25 wt. % of TPU. In some embodiments, the capstock includes 2 wt. % to 25 wt. % of TPU. In some embodiments, the capstock includes 3 wt. % to 25 wt. % of TPU. In some embodiments, the capstock includes 4 wt. % to 25 wt. % of TPU. In some embodiments, the capstock includes 5 wt. % to 25 wt. % of TPU. In some embodiments, the capstock includes 10 wt. % to 25 wt. % of TPU. In some embodiments, the capstock includes 15 wt. % to 25 wt. % of TPU. In some embodiments, the capstock includes 20 wt. % to 25 wt. % of TPU.

In some embodiments, the capstock includes 1 wt. % to 20 wt. % of TPU. In some embodiments, the capstock includes 2 wt. % to 20 wt. % of TPU. In some embodiments, the capstock includes 3 wt. % to 20 wt. % of TPU. In some embodiments, the capstock includes 4 wt. % to 20 wt. % of TPU. In some embodiments, the capstock includes 5 wt. % to 20 wt. % of TPU. In some embodiments, the capstock includes 10 wt. % to 20 wt. % of TPU. In some embodiments, the capstock includes 15 wt. % to 20 wt. % of TPU. In some embodiments, the capstock includes 1 wt. % to 15 wt. % of TPU.

In some embodiments, the capstock includes 2 wt. % to 15 wt. % of TPU. In some embodiments, the capstock includes 3 wt. % to 15 wt. % of TPU. In some embodiments, the capstock includes 4 wt. % to 15 wt. % of TPU. In some embodiments, the capstock includes 5 wt. % to 15 wt. % of TPU. In some embodiments, the capstock includes 10 wt. % to 15 wt. % of TPU.

In some embodiments, the capstock includes 1 wt. % to 10 wt. % of TPU. In some embodiments, the capstock includes 2 wt. % to 10 wt. % of TPU. In some embodiments, the capstock includes 3 wt. % to 10 wt. % of TPU. In some embodiments, the capstock includes 4 wt. % to 10 wt. % of TPU. In some embodiments, the capstock includes 5 wt. % to 10 wt. % of TPU.

In some embodiments, the capstock includes 1 wt. % to 5 wt. % of TPU. In some embodiments, the capstock includes 2 wt. % to 5 wt. % of TPU. In some embodiments, the capstock includes 3 wt. % to 5 wt. % of TPU. In some embodiments, the capstock includes 4 wt. % to 5 wt. % of TPU.

In some embodiments, the capstock includes 1 wt. % to 4 wt. % of TPU. In some embodiments, the capstock includes 2 wt. % to 4 wt. % of TPU. In some embodiments, the capstock includes 3 wt. % to 4 wt. % of TPU.

In some embodiments, the capstock includes 1 wt. % to 3 wt. % of TPU. In some embodiments, the capstock includes 2 wt. % to 3 wt. % of TPU. In some embodiments, the capstock includes 1 wt. % to 2 wt. % of TPU. In some embodiments, the capstock does not include TPU.

Thermoplastic Elastomer Other than TPU

As stated, in some embodiments, the capstock includes a thermoplastic elastomer other than TPU. In some embodiments, the capstock includes both TPU and a thermoplastic elastomer other than TPU. In some embodiments, the thermoplastic elastomer includes styrene-isobutylene-styrene (SIBS). In some embodiments, the thermoplastic elastomer includes SIBS and styrene-isobutylene (SIB). In some embodiments, the thermoplastic elastomer includes a tri-block type SIBS. In some embodiments, the thermoplastic elastomer includes a di-block type SIB. In some embodiments, the thermoplastic elastomer includes a tri-block type SIBS and a di-block type SIB. In some embodiments, the thermoplastic elastomer includes a thermoplastic copolyester elastomer. In some embodiments, the thermoplastic elastomer includes a block copolymer.

In some embodiments, the capstock includes 1 wt. % to 30 wt. % of a thermoplastic other than TPU, based on a total weight of the capstock, regardless of whether the capstock does or does not include TPU. In some embodiments, the capstock includes 2 wt. % to 30 wt. % of the thermoplastic other than TPU. In some embodiments, the capstock includes 3 wt. % to 30 wt. % of the thermoplastic other than TPU. In some embodiments, the capstock includes 4 wt. % to 30 wt. % of the thermoplastic other than TPU. In some embodiments, the capstock includes 5 wt. % to 30 wt. % of the thermoplastic other than TPU. In some embodiments, the capstock includes 6 wt. % to 30 wt. % of the thermoplastic other than TPU. In some embodiments, the capstock includes 7 wt. % to 30 wt. % of the thermoplastic other than TPU. In some embodiments, the capstock includes 8 wt. % to 30 wt. % of the thermoplastic other than TPU. In some embodiments, the capstock includes 9 wt. % to 30 wt. % of the thermoplastic other than TPU. In some embodiments, the capstock includes 10 wt. % to 30 wt. % of the thermoplastic other than TPU. In some embodiments, the capstock includes 11 wt. % to 30 wt. % of the thermoplastic other than TPU. In some embodiments, the capstock includes 12 wt. % to 30 wt. % of the thermoplastic other than TPU. In some embodiments, the capstock includes 13 wt. % to 30 wt. % of the thermoplastic other than TPU. In some embodiments, the capstock includes 14 wt. % to 30 wt. % of the thermoplastic other than TPU. In some embodiments, the capstock includes 15 wt. % to 30 wt. % of the thermoplastic other than TPU. In some embodiments, the capstock includes 16 wt. % to 30 wt. % of the thermoplastic other than TPU. In some embodiments, the capstock includes 17 wt. % to 30 wt. % of the thermoplastic other than TPU. In some embodiments, the capstock includes 18 wt. % to 30 wt. % of the thermoplastic other than TPU. In some embodiments, the capstock includes 19 wt. % to 30 wt. % of the thermoplastic other than TPU. In some embodiments, the capstock includes 20 wt. % to 30 wt. % of the thermoplastic other than TPU. In some embodiments, the capstock includes 21 wt. % to 30 wt. % of the thermoplastic other than TPU. In some embodiments, the capstock includes 22 wt. % to 30 wt. % of the thermoplastic other than TPU. In some embodiments, the capstock includes 23 wt. % to 30 wt. % of the thermoplastic other than TPU. In some embodiments, the capstock includes 24 wt. % to 30 wt. % of the thermoplastic other than TPU. In some embodiments, the capstock includes 25 wt. % to 30 wt. % of the thermoplastic other than TPU.

In some embodiments, the capstock includes 1 wt. % to 25 wt. % of the thermoplastic other than TPU. In some embodiments, the capstock includes 2 wt. % to 25 wt. % of the thermoplastic other than TPU. In some embodiments, the capstock includes 3 wt. % to 25 wt. % of the thermoplastic other than TPU. In some embodiments, the capstock includes 4 wt. % to 25 wt. % of the thermoplastic other than TPU. In some embodiments, the capstock includes 5 wt. % to 25 wt. % of the thermoplastic other than TPU. In some embodiments, the capstock includes 6 wt. % to 25 wt. % of the thermoplastic other than TPU. In some embodiments, the capstock includes 7 wt. % to 25 wt. % of the thermoplastic other than TPU. In some embodiments, the capstock includes 8 wt. % to 25 wt. % of the thermoplastic other than TPU. In some embodiments, the capstock includes 9 wt. % to 25 wt. % of the thermoplastic other than TPU. In some embodiments, the capstock includes 10 wt. % to 25 wt. % of the thermoplastic other than TPU. In some embodiments, the capstock includes 11 wt. % to 25 wt. % of the thermoplastic other than TPU. In some embodiments, the capstock includes 12 wt. % to 25 wt. % of the thermoplastic other than TPU. In some embodiments, the capstock includes 13 wt. % to 25 wt. % of the thermoplastic other than TPU. In some embodiments, the capstock includes 14 wt. % to 25 wt. % of the thermoplastic other than TPU. In some embodiments, the capstock includes 15 wt. % to 25 wt. % of the thermoplastic other than TPU. In some embodiments, the capstock includes 16 wt. % to 25 wt. % of the thermoplastic other than TPU. In some embodiments, the capstock includes 17 wt. % to 25 wt. % of the thermoplastic other than TPU. In some embodiments, the capstock includes 18 wt. % to 25 wt. % of the thermoplastic other than TPU. In some embodiments, the capstock includes 19 wt. % to 25 wt. % of the thermoplastic other than TPU. In some embodiments, the capstock includes 20 wt. % to 25 wt. % of the thermoplastic other than TPU. In some embodiments, the capstock includes 21 wt. % to 25 wt. % of the thermoplastic other than TPU. In some embodiments, the capstock includes 22 wt. % to 25 wt. % of the thermoplastic other than TPU. In some embodiments, the capstock includes 23 wt. % to 25 wt. % of the thermoplastic other than TPU. In some embodiments, the capstock includes 24 wt. % to 25 wt. % of the thermoplastic other than TPU.

In some embodiments, the capstock includes 1 wt. % to 24 wt. % of the thermoplastic other than TPU. In some embodiments, the capstock includes 2 wt. % to 24 wt. % of the thermoplastic other than TPU. In some embodiments, the capstock includes 3 wt. % to 24 wt. % of the thermoplastic other than TPU. In some embodiments, the capstock includes 4 wt. % to 24 wt. % of the thermoplastic other than TPU. In some embodiments, the capstock includes 5 wt. % to 24 wt. % of the thermoplastic other than TPU. In some embodiments, the capstock includes 6 wt. % to 24 wt. % of the thermoplastic other than TPU. In some embodiments, the capstock includes 7 wt. % to 24 wt. % of the thermoplastic other than TPU. In some embodiments, the capstock includes 8 wt. % to 24 wt. % of the thermoplastic other than TPU. In some embodiments, the capstock includes 9 wt. % to 24 wt. % of the thermoplastic other than TPU. In some embodiments, the capstock includes 10 wt. % to 24 wt. % of the thermoplastic other than TPU. In some embodiments, the capstock includes 11 wt. % to 24 wt. % of the thermoplastic other than TPU. In some embodiments, the capstock includes 12 wt. % to 24 wt. % of the thermoplastic other than TPU. In some embodiments, the capstock includes 13 wt. % to 24 wt. % of the thermoplastic other than TPU. In some embodiments, the capstock includes 14 wt. % to 24 wt. % of the thermoplastic other than TPU. In some embodiments, the capstock includes 15 wt. % to 24 wt. % of the thermoplastic other than TPU. In some embodiments, the capstock includes 16 wt. % to 24 wt. % of the thermoplastic other than TPU. In some embodiments, the capstock includes 17 wt. % to 24 wt. % of the thermoplastic other than TPU. In some embodiments, the capstock includes 18 wt. % to 24 wt. % of the thermoplastic other than TPU. In some embodiments, the capstock includes 19 wt. % to 24 wt. % of the thermoplastic other than TPU. In some embodiments, the capstock includes 20 wt. % to 24 wt. % of the thermoplastic other than TPU. In some embodiments, the capstock includes 21 wt. % to 24 wt. % of the thermoplastic other than TPU. In some embodiments, the capstock includes 22 wt. % to 24 wt. % of the thermoplastic other than TPU. In some embodiments, the capstock includes 23 wt. % to 24 wt. % of the thermoplastic other than TPU.

In some embodiments, the capstock includes 1 wt. % to 23 wt. % of the thermoplastic other than TPU. In some embodiments, the capstock includes 2 wt. % to 23 wt. % of the thermoplastic other than TPU. In some embodiments, the capstock includes 3 wt. % to 23 wt. % of the thermoplastic other than TPU. In some embodiments, the capstock includes 4 wt. % to 23 wt. % of the thermoplastic other than TPU. In some embodiments, the capstock includes 5 wt. % to 23 wt. % of the thermoplastic other than TPU. In some embodiments, the capstock includes 6 wt. % to 23 wt. % of the thermoplastic other than TPU. In some embodiments, the capstock includes 7 wt. % to 23 wt. % of the thermoplastic other than TPU. In some embodiments, the capstock includes 8 wt. % to 23 wt. % of the thermoplastic other than TPU. In some embodiments, the capstock includes 9 wt. % to 23 wt. % of the thermoplastic other than TPU. In some embodiments, the capstock includes 10 wt. % to 23 wt. % of the thermoplastic other than TPU. In some embodiments, the capstock includes 11 wt. % to 23 wt. % of the thermoplastic other than TPU. In some embodiments, the capstock includes 12 wt. % to 23 wt. % of the thermoplastic other than TPU. In some embodiments, the capstock includes 13 wt. % to 23 wt. % of the thermoplastic other than TPU. In some embodiments, the capstock includes 14 wt. % to 23 wt. % of the thermoplastic other than TPU. In some embodiments, the capstock includes 15 wt. % to 23 wt. % of the thermoplastic other than TPU. In some embodiments, the capstock includes 16 wt. % to 23 wt. % of the thermoplastic other than TPU. In some embodiments, the capstock includes 17 wt. % to 23 wt. % of the thermoplastic other than TPU. In some embodiments, the capstock includes 18 wt. % to 23 wt. % of the thermoplastic other than TPU. In some embodiments, the capstock includes 19 wt. % to 23 wt. % of the thermoplastic other than TPU. In some embodiments, the capstock includes 20 wt. % to 23 wt. % of the thermoplastic other than TPU. In some embodiments, the capstock includes 21 wt. % to 23 wt. % of the thermoplastic other than TPU. In some embodiments, the capstock includes 22 wt. % to 23 wt. % of the thermoplastic other than TPU.

In some embodiments, the capstock includes 1 wt. % to 22 wt. % of the thermoplastic other than TPU. In some embodiments, the capstock includes 2 wt. % to 22 wt. % of the thermoplastic other than TPU. In some embodiments, the capstock includes 3 wt. % to 22 wt. % of the thermoplastic other than TPU. In some embodiments, the capstock includes 4 wt. % to 22 wt. % of the thermoplastic other than TPU. In some embodiments, the capstock includes 5 wt. % to 22 wt. % of the thermoplastic other than TPU. In some embodiments, the capstock includes 6 wt. % to 22 wt. % of the thermoplastic other than TPU. In some embodiments, the capstock includes 7 wt. % to 22 wt. % of the thermoplastic other than TPU. In some embodiments, the capstock includes 8 wt. % to 22 wt. % of the thermoplastic other than TPU. In some embodiments, the capstock includes 9 wt. % to 22 wt. % of the thermoplastic other than TPU. In some embodiments, the capstock includes 10 wt. % to 22 wt. % of the thermoplastic other than TPU. In some embodiments, the capstock includes 11 wt. % to 22 wt. % of the thermoplastic other than TPU. In some embodiments, the capstock includes 12 wt. % to 22 wt. % of the thermoplastic other than TPU. In some embodiments, the capstock includes 13 wt. % to 22 wt. % of the thermoplastic other than TPU. In some embodiments, the capstock includes 14 wt. % to 22 wt. % of the thermoplastic other than TPU. In some embodiments, the capstock includes 15 wt. % to 22 wt. % of the thermoplastic other than TPU. In some embodiments, the capstock includes 16 wt. % to 22 wt. % of the thermoplastic other than TPU. In some embodiments, the capstock includes 17 wt. % to 22 wt. % of the thermoplastic other than TPU. In some embodiments, the capstock includes 18 wt. % to 22 wt. % of the thermoplastic other than TPU. In some embodiments, the capstock includes 19 wt. % to 22 wt. % of the thermoplastic other than TPU. In some embodiments, the capstock includes 20 wt. % to 22 wt. % of the thermoplastic other than TPU. In some embodiments, the capstock includes 21 wt. % to 22 wt. % of the thermoplastic other than TPU.

In some embodiments, the capstock includes 1 wt. % to 21 wt. % of the thermoplastic other than TPU. In some embodiments, the capstock includes 2 wt. % to 21 wt. % of the thermoplastic other than TPU. In some embodiments, the capstock includes 3 wt. % to 21 wt. % of the thermoplastic other than TPU. In some embodiments, the capstock includes 4 wt. % to 21 wt. % of the thermoplastic other than TPU. In some embodiments, the capstock includes 5 wt. % to 21 wt. % of the thermoplastic other than TPU. In some embodiments, the capstock includes 6 wt. % to 21 wt. % of the thermoplastic other than TPU. In some embodiments, the capstock includes 7 wt. % to 21 wt. % of the thermoplastic other than TPU. In some embodiments, the capstock includes 8 wt. % to 21 wt. % of the thermoplastic other than TPU. In some embodiments, the capstock includes 9 wt. % to 21 wt. % of the thermoplastic other than TPU. In some embodiments, the capstock includes 10 wt. % to 21 wt. % of the thermoplastic other than TPU. In some embodiments, the capstock includes 11 wt. % to 21 wt. % of the thermoplastic other than TPU. In some embodiments, the capstock includes 12 wt. % to 21 wt. % of the thermoplastic other than TPU. In some embodiments, the capstock includes 13 wt. % to 21 wt. % of the thermoplastic other than TPU. In some embodiments, the capstock includes 14 wt. % to 21 wt. % of the thermoplastic other than TPU. In some embodiments, the capstock includes 15 wt. % to 21 wt. % of the thermoplastic other than TPU. In some embodiments, the capstock includes 16 wt. % to 21 wt. % of the thermoplastic other than TPU. In some embodiments, the capstock includes 17 wt. % to 21 wt. % of the thermoplastic other than TPU. In some embodiments, the capstock includes 18 wt. % to 21 wt. % of the thermoplastic other than TPU. In some embodiments, the capstock includes 19 wt. % to 21 wt. % of the thermoplastic other than TPU. In some embodiments, the capstock includes 20 wt. % to 21 wt. % of the thermoplastic other than TPU.

In some embodiments, the capstock includes 1 wt. % to 20 wt. % of the thermoplastic other than TPU. In some embodiments, the capstock includes 2 wt. % to 20 wt. % of the thermoplastic other than TPU. In some embodiments, the capstock includes 3 wt. % to 20 wt. % of the thermoplastic other than TPU. In some embodiments, the capstock includes 4 wt. % to 20 wt. % of the thermoplastic other than TPU. In some embodiments, the capstock includes 5 wt. % to 20 wt. % of the thermoplastic other than TPU. In some embodiments, the capstock includes 6 wt. % to 20 wt. % of the thermoplastic other than TPU. In some embodiments, the capstock includes 7 wt. % to 20 wt. % of the thermoplastic other than TPU. In some embodiments, the capstock includes 8 wt. % to 20 wt. % of the thermoplastic other than TPU. In some embodiments, the capstock includes 9 wt. % to 20 wt. % of the thermoplastic other than TPU. In some embodiments, the capstock includes 10 wt. % to 20 wt. % of the thermoplastic other than TPU. In some embodiments, the capstock includes 11 wt. % to 20 wt. % of the thermoplastic other than TPU. In some embodiments, the capstock includes 12 wt. % to 20 wt. % of the thermoplastic other than TPU.

In some embodiments, the capstock includes 13 wt. % to 20 wt. % of the thermoplastic other than TPU. In some embodiments, the capstock includes 14 wt. % to 20 wt. % of the thermoplastic other than TPU. In some embodiments, the capstock includes 15 wt. % to 20 wt. % of the thermoplastic other than TPU. In some embodiments, the capstock includes 16 wt. % to 20 wt. % of the thermoplastic other than TPU. In some embodiments, the capstock includes 17 wt. % to 20 wt. % of the thermoplastic other than TPU. In some embodiments, the capstock includes 18 wt. % to 20 wt. % of the thermoplastic other than TPU. In some embodiments, the capstock includes 19 wt. % to 20 wt. % of the thermoplastic other than TPU.

In some embodiments, the capstock includes 1 wt. % to 19 wt. % of the thermoplastic other than TPU. In some embodiments, the capstock includes 2 wt. % to 19 wt. % of the thermoplastic other than TPU. In some embodiments, the capstock includes 3 wt. % to 19 wt. % of the thermoplastic other than TPU. In some embodiments, the capstock includes 4 wt. % to 19 wt. % of the thermoplastic other than TPU. In some embodiments, the capstock includes 5 wt. % to 19 wt. % of the thermoplastic other than TPU. In some embodiments, the capstock includes 6 wt. % to 19 wt. % of the thermoplastic other than TPU. In some embodiments, the capstock includes 7 wt. % to 19 wt. % of the thermoplastic other than TPU. In some embodiments, the capstock includes 8 wt. % to 19 wt. % of the thermoplastic other than TPU. In some embodiments, the capstock includes 9 wt. % to 19 wt. % of the thermoplastic other than TPU. In some embodiments, the capstock includes 10 wt. % to 19 wt. % of the thermoplastic other than TPU. In some embodiments, the capstock includes 11 wt. % to 19 wt. % of the thermoplastic other than TPU. In some embodiments, the capstock includes 12 wt. % to 19 wt. % of the thermoplastic other than TPU. In some embodiments, the capstock includes 13 wt. % to 19 wt. % of the thermoplastic other than TPU. In some embodiments, the capstock includes 14 wt. % to 19 wt. % of the thermoplastic other than TPU. In some embodiments, the capstock includes 15 wt. % to 19 wt. % of the thermoplastic other than TPU. In some embodiments, the capstock includes 16 wt. % to 19 wt. % of the thermoplastic other than TPU. In some embodiments, the capstock includes 17 wt. % to 19 wt. % of the thermoplastic other than TPU. In some embodiments, the capstock includes 18 wt. % to 19 wt. % of the thermoplastic other than TPU.

In some embodiments, the capstock includes 1 wt. % to 18 wt. % of the thermoplastic other than TPU. In some embodiments, the capstock includes 2 wt. % to 18 wt. % of the thermoplastic other than TPU. In some embodiments, the capstock includes 3 wt. % to 18 wt. % of the thermoplastic other than TPU. In some embodiments, the capstock includes 4 wt. % to 18 wt. % of the thermoplastic other than TPU. In some embodiments, the capstock includes 5 wt. % to 18 wt. % of the thermoplastic other than TPU. In some embodiments, the capstock includes 6 wt. % to 18 wt. % of the thermoplastic other than TPU. In some embodiments, the capstock includes 7 wt. % to 18 wt. % of the thermoplastic other than TPU. In some embodiments, the capstock includes 8 wt. % to 18 wt. % of the thermoplastic other than TPU. In some embodiments, the capstock includes 9 wt. % to 18 wt. % of the thermoplastic other than TPU. In some embodiments, the capstock includes 10 wt. % to 18 wt. % of the thermoplastic other than TPU. In some embodiments, the capstock includes 11 wt. % to 18 wt. % of the thermoplastic other than TPU. In some embodiments, the capstock includes 12 wt. % to 18 wt. % of the thermoplastic other than TPU. In some embodiments, the capstock includes 13 wt. % to 18 wt. % of the thermoplastic other than TPU. In some embodiments, the capstock includes 14 wt. % to 18 wt. % of the thermoplastic other than TPU. In some embodiments, the capstock includes 15 wt. % to 18 wt. % of the thermoplastic other than TPU. In some embodiments, the capstock includes 16 wt. % to 18 wt. % of the thermoplastic other than TPU. In some embodiments, the capstock includes 17 wt. % to 18 wt. % of the thermoplastic other than TPU.

In some embodiments, the capstock includes 1 wt. % to 17 wt. % of the thermoplastic other than TPU. In some embodiments, the capstock includes 2 wt. % to 17 wt. % of the thermoplastic other than TPU. In some embodiments, the capstock includes 3 wt. % to 17 wt. % of the thermoplastic other than TPU. In some embodiments, the capstock includes 4 wt. % to 17 wt. % of the thermoplastic other than TPU. In some embodiments, the capstock includes 5 wt. % to 17 wt. % of the thermoplastic other than TPU. In some embodiments, the capstock includes 6 wt. % to 17 wt. % of the thermoplastic other than TPU. In some embodiments, the capstock includes 7 wt. % to 17 wt. % of the thermoplastic other than TPU. In some embodiments, the capstock includes 8 wt. % to 17 wt. % of the thermoplastic other than TPU. In some embodiments, the capstock includes 9 wt. % to 17 wt. % of the thermoplastic other than TPU. In some embodiments, the capstock includes 10 wt. % to 17 wt. % of the thermoplastic other than TPU. In some embodiments, the capstock includes 11 wt. % to 17 wt. % of the thermoplastic other than TPU. In some embodiments, the capstock includes 12 wt. % to 17 wt. % of the thermoplastic other than TPU. In some embodiments, the capstock includes 13 wt. % to 17 wt. % of the thermoplastic other than TPU. In some embodiments, the capstock includes 14 wt. % to 17 wt. % of the thermoplastic other than TPU. In some embodiments, the capstock includes 15 wt. % to 17 wt. % of the thermoplastic other than TPU. In some embodiments, the capstock includes 16 wt. % to 17 wt. % of the thermoplastic other than TPU.

In some embodiments, the capstock includes 1 wt. % to 16 wt. % of the thermoplastic other than TPU. In some embodiments, the capstock includes 2 wt. % to 16 wt. % of the thermoplastic other than TPU. In some embodiments, the capstock includes 3 wt. % to 16 wt. % of the thermoplastic other than TPU. In some embodiments, the capstock includes 4 wt. % to 16 wt. % of the thermoplastic other than TPU. In some embodiments, the capstock includes 5 wt. % to 16 wt. % of the thermoplastic other than TPU. In some embodiments, the capstock includes 6 wt. % to 16 wt. % of the thermoplastic other than TPU. In some embodiments, the capstock includes 7 wt. % to 16 wt. % of the thermoplastic other than TPU. In some embodiments, the capstock includes 8 wt. % to 16 wt. % of the thermoplastic other than TPU. In some embodiments, the capstock includes 9 wt. % to 16 wt. % of the thermoplastic other than TPU. In some embodiments, the capstock includes 10 wt. % to 16 wt. % of the thermoplastic other than TPU. In some embodiments, the capstock includes 11 wt. % to 16 wt. % of the thermoplastic other than TPU. In some embodiments, the capstock includes 12 wt. % to 16 wt. % of the thermoplastic other than TPU. In some embodiments, the capstock includes 13 wt. % to 16 wt. % of the thermoplastic other than TPU. In some embodiments, the capstock includes 14 wt. % to 16 wt. % of the thermoplastic other than TPU. In some embodiments, the capstock includes 15 wt. % to 16 wt. % of the thermoplastic other than TPU.

In some embodiments, the capstock includes 1 wt. % to 15 wt. % of the thermoplastic other than TPU. In some embodiments, the capstock includes 2 wt. % to 15 wt. % of the thermoplastic other than TPU. In some embodiments, the capstock includes 3 wt. % to 15 wt. % of the thermoplastic other than TPU. In some embodiments, the capstock includes 4 wt. % to 15 wt. % of the thermoplastic other than TPU. In some embodiments, the capstock includes 5 wt. % to 15 wt. % of the thermoplastic other than TPU. In some embodiments, the capstock includes 6 wt. % to 15 wt. % of the thermoplastic other than TPU. In some embodiments, the capstock includes 7 wt. % to 15 wt. % of the thermoplastic other than TPU. In some embodiments, the capstock includes 8 wt. % to 15 wt. % of the thermoplastic other than TPU. In some embodiments, the capstock includes 9 wt. % to 15 wt. % of the thermoplastic other than TPU. In some embodiments, the capstock includes 10 wt. % to 15 wt. % of the thermoplastic other than TPU. In some embodiments, the capstock includes 11 wt. % to 15 wt. % of the thermoplastic other than TPU. In some embodiments, the capstock includes 12 wt. % to 15 wt. % of the thermoplastic other than TPU. In some embodiments, the capstock includes 13 wt. % to 15 wt. % of the thermoplastic other than TPU. In some embodiments, the capstock includes 14 wt. % to 15 wt. % of the thermoplastic other than TPU.

In some embodiments, the capstock includes 1 wt. % to 14 wt. % of the thermoplastic other than TPU. In some embodiments, the capstock includes 2 wt. % to 14 wt. % of the thermoplastic other than TPU. In some embodiments, the capstock includes 3 wt. % to 14 wt. % of the thermoplastic other than TPU. In some embodiments, the capstock includes 4 wt. % to 14 wt. % of the thermoplastic other than TPU. In some embodiments, the capstock includes 5 wt. % to 14 wt. % of the thermoplastic other than TPU. In some embodiments, the capstock includes 6 wt. % to 14 wt. % of the thermoplastic other than TPU. In some embodiments, the capstock includes 7 wt. % to 14 wt. % of the thermoplastic other than TPU. In some embodiments, the capstock includes 8 wt. % to 14 wt. % of the thermoplastic other than TPU. In some embodiments, the capstock includes 9 wt. % to 14 wt. % of the thermoplastic other than TPU. In some embodiments, the capstock includes 10 wt. % to 14 wt. % of the thermoplastic other than TPU. In some embodiments, the capstock includes 11 wt. % to 14 wt. % of the thermoplastic other than TPU. In some embodiments, the capstock includes 12 wt. % to 14 wt. % of the thermoplastic other than TPU. In some embodiments, the capstock includes 13 wt. % to 14 wt. % of the thermoplastic other than TPU.

In some embodiments, the capstock includes 1 wt. % to 13 wt. % of the thermoplastic other than TPU. In some embodiments, the capstock includes 2 wt. % to 13 wt. % of the thermoplastic other than TPU. In some embodiments, the capstock includes 3 wt. % to 13 wt. % of the thermoplastic other than TPU. In some embodiments, the capstock includes 4 wt. % to 13 wt. % of the thermoplastic other than TPU. In some embodiments, the capstock includes 5 wt. % to 13 wt. % of the thermoplastic other than TPU. In some embodiments, the capstock includes 6 wt. % to 13 wt. % of the thermoplastic other than TPU. In some embodiments, the capstock includes 7 wt. % to 13 wt. % of the thermoplastic other than TPU. In some embodiments, the capstock includes 8 wt. % to 13 wt. % of the thermoplastic other than TPU. In some embodiments, the capstock includes 9 wt. % to 13 wt. % of the thermoplastic other than TPU. In some embodiments, the capstock includes 10 wt. % to 13 wt. % of the thermoplastic other than TPU. In some embodiments, the capstock includes 11 wt. % to 13 wt. % of the thermoplastic other than TPU. In some embodiments, the capstock includes 12 wt. % to 13 wt. % of the thermoplastic other than TPU.

In some embodiments, the capstock includes 1 wt. % to 12 wt. % of the thermoplastic other than TPU. In some embodiments, the capstock includes 2 wt. % to 12 wt. % of the thermoplastic other than TPU. In some embodiments, the capstock includes 3 wt. % to 12 wt. % of the thermoplastic other than TPU. In some embodiments, the capstock includes 4 wt. % to 12 wt. % of the thermoplastic other than TPU. In some embodiments, the capstock includes 5 wt. % to 12 wt. % of the thermoplastic other than TPU. In some embodiments, the capstock includes 6 wt. % to 12 wt. % of the thermoplastic other than TPU. In some embodiments, the capstock includes 7 wt. % to 12 wt. % of the thermoplastic other than TPU. In some embodiments, the capstock includes 8 wt. % to 12 wt. % of the thermoplastic other than TPU. In some embodiments, the capstock includes 9 wt. % to 12 wt. % of the thermoplastic other than TPU. In some embodiments, the capstock includes 10 wt. % to 12 wt. % of the thermoplastic other than TPU. In some embodiments, the capstock includes 11 wt. % to 12 wt. % of the thermoplastic other than TPU.

In some embodiments, the capstock includes 1 wt. % to 11 wt. % of the thermoplastic other than TPU. In some embodiments, the capstock includes 2 wt. % to 11 wt. % of the thermoplastic other than TPU. In some embodiments, the capstock includes 3 wt. % to 11 wt. % of the thermoplastic other than TPU. In some embodiments, the capstock includes 4 wt. % to 11 wt. % of the thermoplastic other than TPU. In some embodiments, the capstock includes 5 wt. % to 11 wt. % of the thermoplastic other than TPU. In some embodiments, the capstock includes 6 wt. % to 11 wt. % of the thermoplastic other than TPU. In some embodiments, the capstock includes 7 wt. % to 11 wt. % of the thermoplastic other than TPU. In some embodiments, the capstock includes 8 wt. % to 11 wt. % of the thermoplastic other than TPU. In some embodiments, the capstock includes 9 wt. % to 11 wt. % of the thermoplastic other than TPU. In some embodiments, the capstock includes 10 wt. % to 11 wt. % of the thermoplastic other than TPU.

In some embodiments, the capstock includes 1 wt. % to 10 wt. % of the thermoplastic other than TPU. In some embodiments, the capstock includes 2 wt. % to 10 wt. % of the thermoplastic other than TPU. In some embodiments, the capstock includes 3 wt. % to 10 wt. % of the thermoplastic other than TPU. In some embodiments, the capstock includes 4 wt. % to 10 wt. % of the thermoplastic other than TPU. In some embodiments, the capstock includes 5 wt. % to 10 wt. % of the thermoplastic other than TPU. In some embodiments, the capstock includes 6 wt. % to 10 wt. % of the thermoplastic other than TPU. In some embodiments, the capstock includes 7 wt. % to 10 wt. % of the thermoplastic other than TPU. In some embodiments, the capstock includes 8 wt. % to 10 wt. % of the thermoplastic other than TPU. In some embodiments, the capstock includes 9 wt. % to 10 wt. % of the thermoplastic other than TPU.

In some embodiments, the capstock includes 1 wt. % to 9 wt. % of the thermoplastic other than TPU. In some embodiments, the capstock includes 2 wt. % to 9 wt. % of the thermoplastic other than TPU. In some embodiments, the capstock includes 3 wt. % to 9 wt. % of the thermoplastic other than TPU. In some embodiments, the capstock includes 4 wt. % to 9 wt. % of the thermoplastic other than TPU. In some embodiments, the capstock includes 5 wt. % to 9 wt. % of the thermoplastic other than TPU. In some embodiments, the capstock includes 6 wt. % to 9 wt. % of the thermoplastic other than TPU. In some embodiments, the capstock includes 7 wt. % to 9 wt. % of the thermoplastic other than TPU. In some embodiments, the capstock includes 8 wt. % to 9 wt. % of the thermoplastic other than TPU.

In some embodiments, the capstock includes 1 wt. % to 8 wt. % of the thermoplastic other than TPU. In some embodiments, the capstock includes 2 wt. % to 8 wt. % of the thermoplastic other than TPU. In some embodiments, the capstock includes 3 wt. % to 8 wt. % of the thermoplastic other than TPU. In some embodiments, the capstock includes 4 wt. % to 8 wt. % of the thermoplastic other than TPU. In some embodiments, the capstock includes 5 wt. % to 8 wt. % of the thermoplastic other than TPU. In some embodiments, the capstock includes 6 wt. % to 8 wt. % of the thermoplastic other than TPU. In some embodiments, the capstock includes 7 wt. % to 8 wt. % of the thermoplastic other than TPU.

In some embodiments, the capstock includes 1 wt. % to 7 wt. % of the thermoplastic other than TPU. In some embodiments, the capstock includes 2 wt. % to 7 wt. % of the thermoplastic other than TPU. In some embodiments, the capstock includes 3 wt. % to 7 wt. % of the thermoplastic other than TPU. In some embodiments, the capstock includes 4 wt. % to 7 wt. % of the thermoplastic other than TPU. In some embodiments, the capstock includes 5 wt. % to 7 wt. % of the thermoplastic other than TPU. In some embodiments, the capstock includes 6 wt. % to 7 wt. % of the thermoplastic other than TPU.

In some embodiments, the capstock includes 1 wt. % to 6 wt. % of the thermoplastic other than TPU. In some embodiments, the capstock includes 2 wt. % to 6 wt. % of the thermoplastic other than TPU. In some embodiments, the capstock includes 3 wt. % to 6 wt. % of the thermoplastic other than TPU. In some embodiments, the capstock includes 4 wt. % to 6 wt. % of the thermoplastic other than TPU. In some embodiments, the capstock includes 5 wt. % to 6 wt. % of the thermoplastic other than TPU.

In some embodiments, the capstock includes 1 wt. % to 5 wt. % of the thermoplastic other than TPU. In some embodiments, the capstock includes 2 wt. % to 5 wt. % of the thermoplastic other than TPU. In some embodiments, the capstock includes 3 wt. % to 5 wt. % of the thermoplastic other than TPU. In some embodiments, the capstock includes 4 wt. % to 5 wt. % of the thermoplastic other than TPU.

In some embodiments, the capstock includes 1 wt. % to 4 wt. % of the thermoplastic other than TPU. In some embodiments, the capstock includes 2 wt. % to 4 wt. % of the thermoplastic other than TPU. In some embodiments, the capstock includes 3 wt. % to 4 wt. % of the thermoplastic other than TPU.

In some embodiments, the capstock includes 1 wt. % to 3 wt. % of the thermoplastic other than TPU. In some embodiments, the capstock includes 2 wt. % to 3 wt. % of the thermoplastic other than TPU. In some embodiments, the capstock includes 1 wt. % to 2 wt. % of the thermoplastic other than TPU.

In some embodiments, TPU is entirely excluded from the capstock.

### Optional Additives

As stated, in some embodiments, the capstock includes one or more optional additives. In some embodiments, the optional additive includes one or more of a colorant, pigment, plasticizer, lubricant, UV stabilizer, light stabilizer, thermal stabilizer, antioxidant, antistatic agent, flame retardant, filler, fiber, processing aid, biocide, surfactant, blowing agent, foaming agent, wax, and/or combinations thereof.

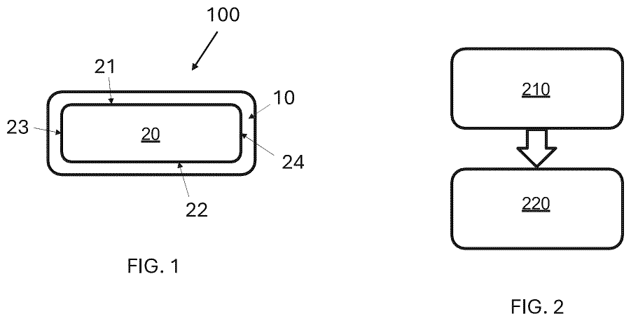

With reference to the drawings, FIG. 1 is a schematic cross-sectional view of a building material, in accordance with some embodiments of the invention. As FIG. 1 shows, in some embodiments, the building material 100 is a composite board, including a capstock 10 and a core 20. In some embodiments, the capstock 10 at least partially covers one or more surfaces of the core 20, such as a top surface 21, a bottom surface 22, a first side surface 23, and a second side surface 24. It is of course understood that the building material may be oriented such that any outer surface may be designated as “top,” “bottom,” and “side” depending on the specific orientation. Thus, in some embodiments, the capstock covers an outer surface of the core 20.

FIG. 2 is a block diagram of a method of forming the building material, in accordance with some embodiments of the invention. As FIG. 2 shows, in some embodiments, the method includes obtaining formulations for the capstock and the core, as represented by block 210. As the figure also shows, in some embodiments, the capstock is coextruded with the core, as represented by block 220. In some embodiments, coextrusion results in opposite ends of the core being uncovered, while other outer surfaces of the core are covered by the capstock.

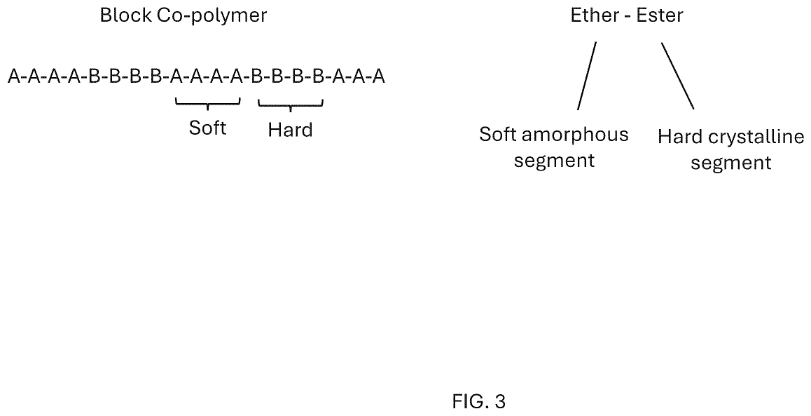

Referring to FIG. 3, shown is a schematic diagram of a block copolymer having alternating hard and soft segments. In some examples, a thermoplastic elastomer may include a block copolymer having alternating hard segments formed from polyester and soft segments formed from polyether or polyester.

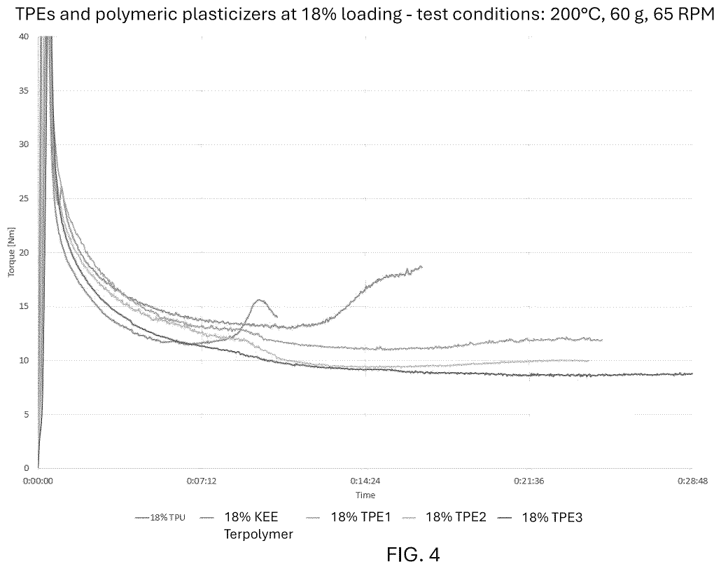

FIG. 4 illustrates the evolution of torque measured in test pellets of capstock material with different compositions as a function of time and temperature. The choice of thermoplastic elastomer or plasticizer in the capstock formulation may influence both the extrusion characteristics and the long-term stability of a composite article. The torque data were measured in accordance with ASTM D2538 and provide an indication of viscosity and thermal stability.

As used herein, dynamic thermal stability (DTS) may be evaluated in terms of the length of time a material remains stable before degradation occurs. This is indicated by a sudden, sharp rise in the torque curve as the material starts to break down and cross-linking occurs. Degradation generally occurs gradually, with color changes typically appearing first as chromophores, such as double bonds forming in the PVC backbone, develop. These color changes precede the onset of catastrophic cross-linking, which is indicated by a sharp increase in torque.

Referring to FIG. 4, upward trending of the curves for the TPU and polymeric plasticizer materials approaching the conclusion of the test is indicative of cross-linking during thermal degradation. In the case of the non-TPU TPE compositions, however, no upward trend was observed. Rather, the non-TPU TPE materials surprisingly demonstrated a slight downward inflection possibly indicative of chain scission, followed by a long running substantially flat line indicative of improved thermal stability. Co-polymer thermoplastic elastomers generally imparted greater extrusion torque than TPU at equivalent loading.

In some embodiments, a capstock composition exhibits a torque increase of less than 15% from its minimum measured value over the course of the test. That is, the torque measured subsequent to the test's minimum measured value increases by less than 15% from the minimum value. This metric provides a quantitative indication of the material's resistance to thermal degradation, with a lower percentage increase in torque reflecting greater thermal stability and processability under extrusion conditions. In some embodiments, the increase in torque from the minimum measured value may be 0, 1, 2, 4, 5, 10, or 15%, including ranges between any of the foregoing values. In some embodiments, the duration of the test is at least 5 min, e.g., 5, 10, 15, 20, 25, or 30 min, including ranges between any of the foregoing values.

In FIGS. 4-9, the samples identified as TPE1 include a polyester elastomer having a Shore D hardness of approximately 60, the TPE2 compositions include a polyester elastomer having a Shore D hardness of approximately 40, and the TPE 3 compositions include a polyester elastomer having a Shore D hardness of approximately 25.

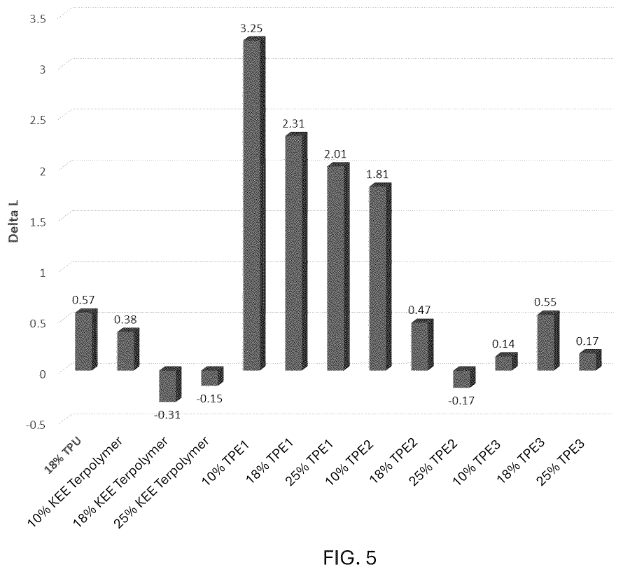

FIG. 5 is a plot showing Taber abrasion results for example capstock materials. The data show the weight loss of each capstock sample after undergoing abrasion testing, which serves as a measure of the material's resistance to wear.

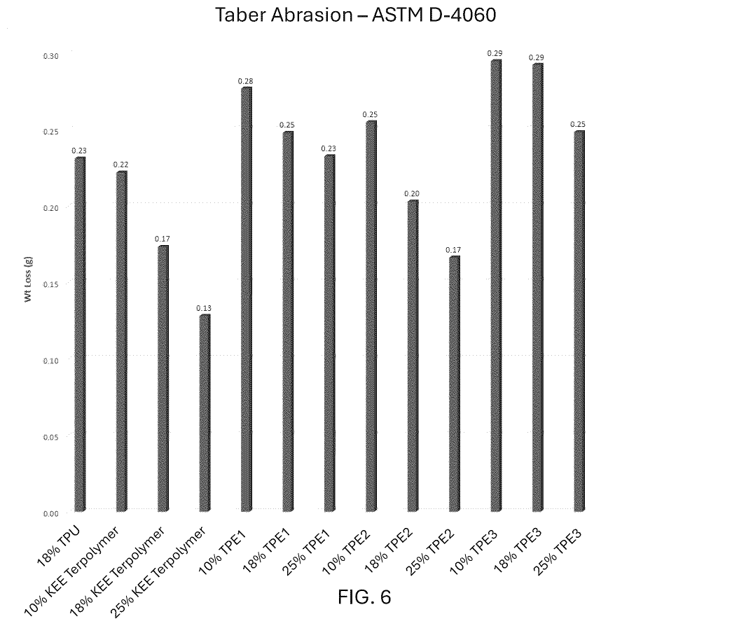

Referring to FIG. 6, shown is the moisture whitening behavior for various example capstock materials. The graph illustrates the change in lightness (Delta L) of the capstock surface following water immersion, which is indicative of moisture whitening resistance. The results highlight the impact of the selected thermoplastic elastomer or plasticizer materials on a capstock's ability to maintain color stability and resist whitening when exposed to moisture.

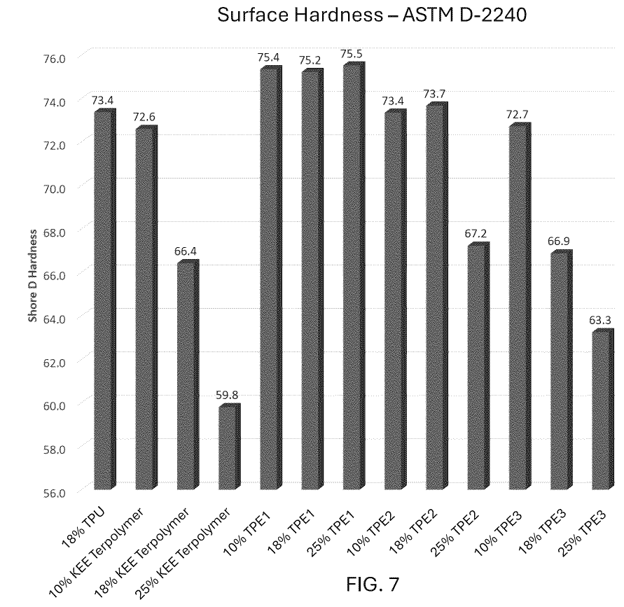

FIG. 7 is a plot showing surface hardness data for composite articles having a capstock layer formed from example capstock materials. The data include Shore D hardness values for extruded strips, providing a measure of the capstock's resistance to indentation and its overall rigidity.

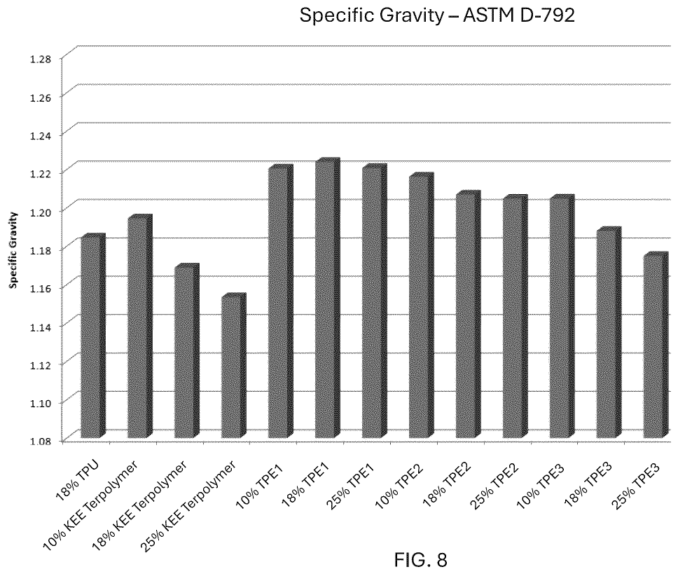

FIG. 8 is a plot showing specific gravity data for example capstock compositions. The plot includes measured specific gravity values for various capstock formulations, which reflect the density of the material and can influence coverage as well as weight of a composite article.

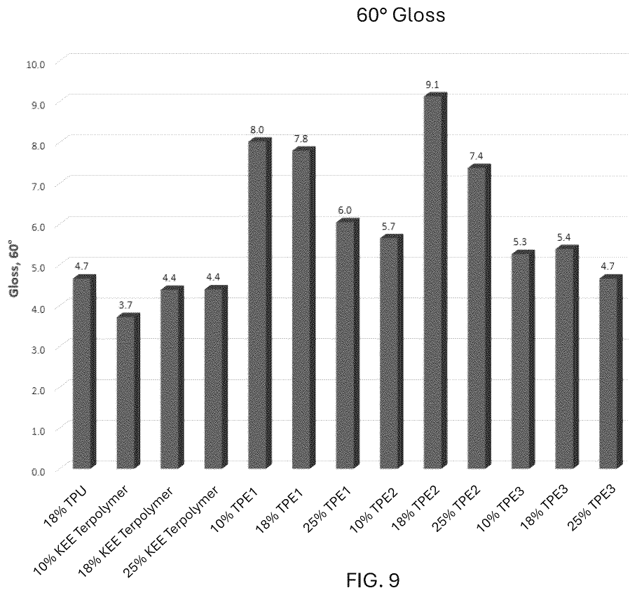

FIG. 9 is a plot showing surface gloss at 60° for composite articles having a capstock layer formed from example capstock materials. The plot displays gloss values measured on extruded strips, which indicate the surface reflectivity and visual appearance of the capstock.

### Comparative Examples—ASTM D4060-19 Testing

In accordance with ASTM D4060-19 Standard Test Method for Abrasion Resistance of Organic Coatings, four capstock materials were manufactured. Each of the materials included the indicated weight percentage of the following components, based on the total weight of the capstock: 39.1 wt. % of PVC, 24.7 wt. % of ASA, and 18.2 wt. % of SAN, with the remaining 18 wt. % of a thermoplastic elastomer or polymeric plasticizer. The thermoplastic elastomer or polymeric plasticizer for each of the capstock materials is as set forth in Table 1.

TABLE 1

| Capstock | Thermoplastic Elastomer or Polymeric |
|---|---|
| Material No. | Plasticizer present at 18 wt. % |
| 1 | TPU |
| 2 | Terpolymer |
| 3 | Thermoplastic copolyester elastomer |
| 4 | SIBS |

Referring also to FIG. 5, evaluation after testing indicates the following weight loss for each of these materials, as set forth in Table 2.

TABLE 2

| Capstock Material No. | Weight loss (grams) |
|---|---|
| 1 | 0.23 |
| 2 | 0.17 |
| 3 | 0.20 |
| 4 | 0.21 |

Thus, each of the capstock materials with thermoplastic elastomers other than TPU performed better than the capstock material with TPU as the thermoplastic elastomer.

### Comparative Examples—Dow Water Immersion-Moisture Whitening Testing

In accordance with the Dow Water Immersion-Moisture Whitening Testing procedure, four capstock materials were manufactured. Each of the materials included the indicated weight percentage of the following components, based on the total weight of the capstock: 39.1 wt. % of PVC, 24.7 wt. % of ASA, and 18.2 wt. % of SAN, with the remaining 18 wt. % of a thermoplastic elastomer or polymeric plasticizer. The thermoplastic elastomer or polymeric plasticizer for each of the capstock materials is as set forth in Table 1 above.

With reference also to FIG. 6, evaluation after testing indicates the following delta L for each of these materials, as set forth in Table 3.

TABLE 3

| Capstock Material No. | Delta L |
|---|---|
| 1 | 0.57 |
| 2 | −0.31 |
| 3 | 0.47 |
| 4 | 0.08 |

Thus, each of the capstock materials with thermoplastic elastomers other than TPU performed better than the capstock material with TPU as the thermoplastic elastomer.

Variations, modifications, and alterations to embodiments of the present disclosure described above will make themselves apparent to those skilled in the art. All such variations, modifications, alterations and the like are intended to fall within the spirit and scope of the present disclosure, limited solely by the appended claims.

While several embodiments of the present disclosure have been described, it is understood that these embodiments are illustrative only, and not restrictive, and that many modifications may become apparent to those of ordinary skill in the art. For example, all dimensions discussed herein are provided as examples only, and are intended to be illustrative and not restrictive.

Any feature or element that is positively identified in this description may also be specifically excluded as a feature or element of an embodiment of the present as defined in the claims.

The disclosure described herein may be practiced in the absence of any element or elements, limitation or limitations, which is not specifically disclosed herein. The terms and expressions which have been employed are used as terms of description and not of limitation, and there is no intention in the use of such terms and expressions of excluding any equivalents of the features shown and described or portions thereof, but it is recognized that various modifications are possible within the scope of the disclosure.

1. A composite article, comprising:
a core; and
a capstock positioned to at least partially cover the core,
wherein the capstock comprises:
a thermoplastic elastomer,
wherein the thermoplastic elastomer does not include thermoplastic polyurethane (TPU), and
a blend of thermoplastic matrix polymers,
wherein the blend thermoplastic matrix polymers comprises, based on a total weight of the capstock:
10 wt. % to 70 wt. % polyvinyl chloride (PVC),
1 wt. % to 60 wt. % acrylonitrile-styrene-acrylate (ASA), and
1 wt. % to 60 wt. % styrene-acrylonitrile (SAN).

2. The composite article of claim 1, wherein the thermoplastic elastomer comprises a thermoplastic copolyester elastomer.

3. The composite article of claim 1, wherein the thermoplastic elastomer comprises a block copolymer.

4. The composite article of claim 1, wherein the thermoplastic elastomer comprises a block copolymer having alternating hard segments formed from polyester and soft segments formed from polyether or polyester.

5. The composite article of claim 1, wherein the thermoplastic elastomer comprises an ether ester elastomer.

6. The composite article of claim 1, wherein the thermoplastic elastomer comprises a styrene-isobutylene-styrene elastomer, a styrene-isobutylene elastomer, or a combination of a styrene-isobutylene-styrene elastomer and a styrene-isobutylene elastomer.

7. The composite article of claim 1, wherein the thermoplastic elastomer comprises a styrene-isobutylene-styrene elastomer.

8. The composite article of claim 1, wherein the capstock comprises 1 wt. % to 60 wt. % of the thermoplastic elastomer.

9. The composite article of claim 1, wherein the capstock comprises 10 wt. % to 25 wt. % of the thermoplastic elastomer.

10. The composite article of claim 1, wherein the thermoplastic matrix polymer comprises:
30 wt. % to 50 wt. % polyvinyl chloride (PVC),
20 wt. % to 40 wt. % acrylonitrile-styrene-acrylate (ASA), and
10 wt. % to 30 wt. % styrene-acrylonitrile (SAN).

11. The composite article of claim 1, wherein the capstock exhibits a Dow water immersion moisture whitening change (ΔL) of less than 1.

12. The composite article of claim 1, wherein the capstock exhibits a weight loss of at most 0.2 g when tested in accordance with ASTM D4060-19.

13. The composite article of claim 1, wherein the capstock exhibits a torque increase of less than 15% from its minimum measured value during dynamic thermal stability testing when tested in accordance with ASTM D2538.

14. The composite article of claim 1, wherein the capstock further comprises at least one additive selected from the group consisting of a colorant, pigment, lubricant, ultraviolet stabilizer, light stabilizer, thermal stabilizer, antioxidant, antistatic agent, flame retardant, filler, fiber, processing aid, biocide, surfactant, blowing agent, foaming agent, and wax.

15. The composite article of claim 1, wherein the capstock does not include thermoplastic polyurethane (TPU).

16. The composite article of claim 1, wherein the composite article comprises a decking board.

17. A composite article, comprising:
a core; and
a capstock positioned to at least partially cover the core,
wherein the capstock comprises:
an additive,
wherein the additive is selected from the group consisting of a polymeric plasticizer and a thermoplastic elastomer, and
a blend of thermoplastic matrix polymers,
wherein the blend of thermoplastic matrix polymers comprises polyvinyl chloride (PVC), acrylonitrile-styrene-acrylate (ASA), and styrene-acrylonitrile (SAN),
wherein the capstock comprises:
1 wt. % to 60 wt. % of the additive,
10 wt. % to 70 wt. % of the polyvinyl chloride (PVC),
1 wt. % to 60 wt. % of the acrylonitrile-styrene-acrylate (ASA),
1 wt. % to 60 wt. % of the styrene-acrylonitrile (SAN), and
the capstock does not include thermoplastic polyurethane (TPU),
wherein the capstock exhibits a Dow water immersion moisture whitening change (ΔL) of less than 1, and
wherein the capstock exhibits a weight loss of at most 0.2 g when tested in accordance with ASTM D4060-19.

18. The composite article of claim 17, wherein the polymeric plasticizer comprises a ketone ethylene ester terpolymer.

19. The composite article of claim 17, wherein the thermoplastic elastomer comprises a thermoplastic copolyester elastomer.

20. The composite article of claim 17, wherein the thermoplastic elastomer comprises a block copolymer.

21. The composite article of claim 17, wherein the capstock comprises:
5 wt. % to 30 wt. % of the additive,
30 wt. % to 50 wt. % polyvinyl chloride (PVC),
20 wt. % to 40 wt. % acrylonitrile-styrene-acrylate (ASA), and
10 wt. % to 30 wt. % styrene-acrylonitrile (SAN).

22. The composite article of claim 17, wherein the capstock exhibits a Dow water immersion moisture whitening change (ΔL) of less than 0.2.

23. The composite article of claim 17, wherein the capstock exhibits a torque increase of less than 15% from its minimum measured value during dynamic thermal stability testing when tested in accordance with ASTM D2538.

24. A method comprising:
coextruding a capstock with a core to form a composite article,
wherein the capstock comprises:
a thermoplastic elastomer,
wherein the thermoplastic elastomer does not include thermoplastic polyurethane (TPU), and
a blend of thermoplastic matrix polymers,
wherein the blend thermoplastic matrix polymers comprises, based on a total weight of the capstock:
10 wt. % to 70 wt. % polyvinyl chloride (PVC),
1 wt. % to 60 wt. % acrylonitrile-styrene-acrylate (ASA), and
1 wt. % to 60 wt. % styrene-acrylonitrile (SAN).

25. The method of claim 24, wherein the capstock comprises 1 wt. % to 60 wt. % of the thermoplastic elastomer.
